(19) United States
(12) Patent Application Publication
(10) Pub. No.: US 2024/0086790 A1
(43) Pub. Date: Mar. 14, 2024

(54) DATA GYRO BULB FOR ILLUMINATING AND ANALYZING DIFFERENCES BETWEEN METRICS AND TARGETS OVER SEQUENCES TO ASSESS, ALERT, AND ACHIEVE AND MAINTAIN TARGETED STATES

(71) Applicant: Data Wheel Analytics Inc., Oakland, CA (US)

(72) Inventor: Jacob William Clark, Oakland, CA (US)

(21) Appl. No.: 18/367,294

(22) Filed: Sep. 12, 2023

Related U.S. Application Data
(60) Provisional application No. 63/375,537, filed on Sep. 13, 2022.

(51) Int. Cl. G06Q 10/063

(52) U.S. Cl. CPC G06Q 10/063; G06Q 20/389

(57) ABSTRACT

Data gyro bulb and associated technology are provided. For example, an electronic informatics system is provided comprising sequential data stream of data blocks. The stream comprises a genesis data block, and each data block of the stream includes a sequence order identifier, an actual value, and a target value. The system also includes metrics that each includes one or more metric components selected from a current gap, a current trend, a cumulative gap, and a cumulative trend. A derivative metric is calculated at each of the data blocks. A derivative assessing means assesses derivative metrics in a manner that is consistent with zero, that is neither substantially positive nor substantially negative, representing a targeted and/or stable state between the actual value and the target value. The system operates via gyro, bot, and/or user adjustment technology to carry out data processing to produce a data gyro bulb.

### CROSS REFERENCE TO RELATED CASES

This case claims priority to U.S. Provisional Patent Application Ser. No. 63/375,573, filed Sep. 13, 2022, entitled “A DATA GYRO BULB FOR ILLUMINATING AND ANALYZING THE DIFFERENCES BETWEEN A METRIC AND ITS TARGET OVER SEQUENCES,” first named inventor William Shifflet, the disclosure of which is incorporated by reference in its entirety.

### BACKGROUND

### Technical Field

This case relates generally to informatics systems and processes that provide smart technologies, such as technologies associated with artificial intelligence. The inventive matter of this case typically involves generation or use of one or more data gyro bulbs in combination with associated zero gap(s) and zero change in gap(s).

### Background Art

Analyzing sequenced data sets is an essential component of many disciplines within science, business, and government. Scrutinizing sequences of data in view of metrics associated therewith can provide valuable insights when conducting data analyses. More information and insights are rendered when analyzing sequences comprised of actual and target values. This is because analyzing actual values alone does not provide any context regarding norms and standards that are of use to users. Target values provide a standard or metric, established or proposed, with which actual values may be assessed and/or judged.

For example, FIGS. 1 to 3 contains three images in the form of hypothetical graphs of data streams and derivatives. FIG. 1 is a graph that displays a hypothetical sequence of data representing actual measured values of a metric of use to a user. That is, FIG. 1 depicts a graph 100 that displays a hypothetical thirteen interval sequence of data representing actual measured values of a metric of use to a user.

FIG. 2 adds target values to the data sequence shown in FIG. 1. Here, graph 200 is shown with target values for each of thirteen intervals in the sequence. These elements comprise a sequence of data with at least one actual metric measurement, at least one target measurement, and a sequence order identifier at each interval, which constitutes source data for Data gyro bulb technology.

FIG. 3 depicts how differences between the actual and target values can and do change over time. The graph 300 depicts how measured differences between an actual and target values can and do change over the intervals of a data sequence.

What is readily apparent when viewing FIGS. 1 to 3 are the general upward and downward positions and directions of the actual and target values. However, by analyzing a metric's gap-to-target (gap) values as seen in FIG. 3, the actual and target data are reduced into a relevant context. By analyzing the gap values, the metric's values are placed in a referenceable context in relation to a predetermined set of target values, at each interval and over the sequence. The magnitude of a metric's gap and the trajectory of the gap, for any interval in a sequence and cumulatively over the sequence to any interval, are important to analyzing metrics sequentially at deeper levels.

Thus, in data analysis, studying the differences between metrics' actual and target values over sequences renders increasingly valuable insights. Target, hypothetical, assumed, and/or referential data for metrics may be extensively created and heavily relied upon for scientists, businesses, governments, and individuals to compare with metrics' actual data to inform, influence decisions, identify patterns, statistically test, and/or make new discoveries. Often, the comparison of a metric's actual and target are made over sequences, often in terms of time. Sequential, comparative analyses of actual and target data are otherwise time consuming and difficult to interpret. The amount of space required and lack of analytical structure for the effective and intuitive summation and analysis of a metric relative to a target over sequences makes interpretation and summation difficult and time consuming.

Therefore, opportunities exist to provide improved systems for carrying out informatic processes. For example, there exist opportunities to provide technology that may involve systems and or methods that employ structured analytical frameworks and/or insights and display architectures to interpret longitudinal metrics at deeper levels in an efficient manner. It is believed that there are, no commercially available products that process, structure, and communicate data to summarize, alert, describe, and/or display the behavior of the differences between actual and target values over sequences in a structured, efficient, intuitive, flexible, and consistent informatic system. Furthermore, it is believed that no commercially available products utilize the superior processes and structures developed herein to statistically model insights and recommendations that reduce the gaps and volatility of the gaps between the actual and target values and/or across multiple metrics of interest. Currently available systems are either inefficient with display space, unintuitive, incomplete, and/or configured for specific fields of interest. In short, there is an opportunity to improve data analysis and other informatics techniques through smart technology implicating artificial intelligence.

### SUMMARY

In a first embodiment, the invention provides an informatics system. The system is comprised of a sequential data stream of data blocks, a set of metrics, a calculating means, and an assessing means. The stream of data blocks comprises a genesis data block, and each data block of the stream of data blocks includes a sequence order identifier, an actual value, and a target value. The set of metrics each includes one or more metric components selected from a calculated gap and a calculated trend of the gap (trend) as defined at a current interval or over cumulative sequencing; thus, the metrics are of a current gap(s), a current trend(s), a cumulative gap(s), and a cumulative trend(s). The calculating means is effective to calculate a derivative metric at each of the data blocks. The assessing means allows for the assessment of derivative metrics in a manner that is consistent with a zero gap and zero trend that is neither substantially positive nor substantially negative representing a desired or expected state and stability between an actual value and a target value.

Typically, the system employs AI technology and is at least partially electronic in character. Thus, the system may operate via gyro, bot, and/or user adjustment technology. As a result, data processing is carried out to produce a data gyro bulb.

In another embodiment, a process is provided. The process may be electronic and allows for frequentative data processing using a processor and memory. The process is typically employed to carry out informatics methods. The process comprises: providing an electronically executable program stored at least partially in the memory and configured to be executed by the processor; receiving a sequential data stream of data blocks, wherein the stream of data blocks includes a genesis data block, and each data block of the stream of data blocks includes a sequence order identifier, an actual measurement, and a target measurement; and calculating derivative metrics of the sequential data stream for each of the data blocks, wherein the derivative metrics each includes at least one of a current gap, a current trend, a cumulative gap, and a cumulative trend. A means for assessment is applied to the derivative metrics at each interval consistent with a zero gap and zero trend.

As a result, a data gyro bulb is generated. The data gyro bulb is effective to facilitate a zero gap and zero trend between actual data values/measurements and target data values/measurements. Consequentially, an optimal, desired, or predetermined (targeted) result may be achieved and maintained, even when the target changes over sequences. When a targeted result is not achieved, the data gyro bulb may provide one or more signals as to how to achieve and maintain a targeted state and results therefrom in the future. If the targeted result is achieved, the data gyro bulb may provide one or more signals as to how to maintain a future targeted result.

In further embodiment, the invention provides generative and/or regenerative technology that employs AI techniques. Such technology allows for generation of at least one data gyro bulb in a smart manner. The embodiment is useful in addressing electronic and other types of archival issues associated with AI that results in the detection of rogue AI artifacts that may arise through use of AI. Because such rogue artifacts affect AI technologies in an unexpected manner, debugging time may be reduced or eliminated.

### BRIEF DESCRIPTION OF THE FIGURES

FIG. 1 is a graph that displays a hypothetical thirteen interval sequence of data representing actual measured values of a metric of use to a user.

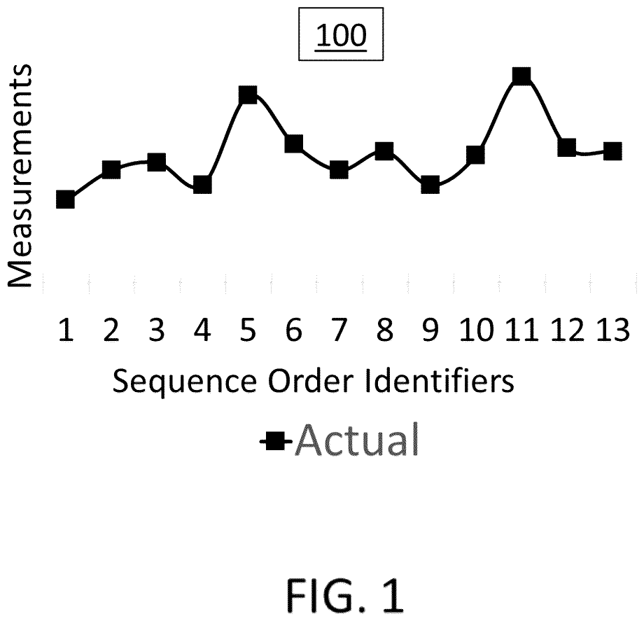

FIG. 2 the same graph from FIG. 1 with target values added for each of the thirteen intervals in the sequence. These elements comprise a sequence of data with at least one actual metric measurement, at least one target measurement, and a sequence order identifier at each interval, which constitutes source data for Data gyro bulb technology.

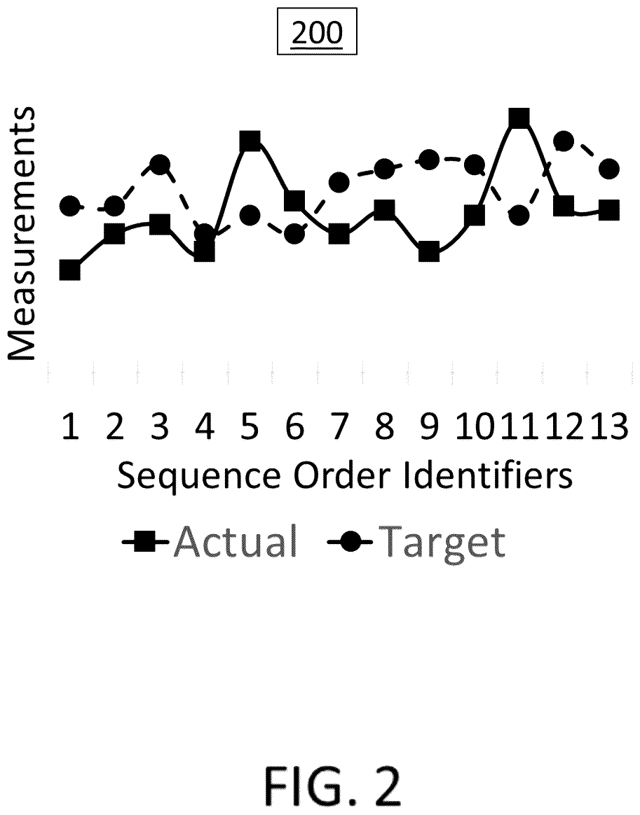

FIG. 3 depicts how measured differences between an actual and target values can and do change over the intervals of a data sequence.

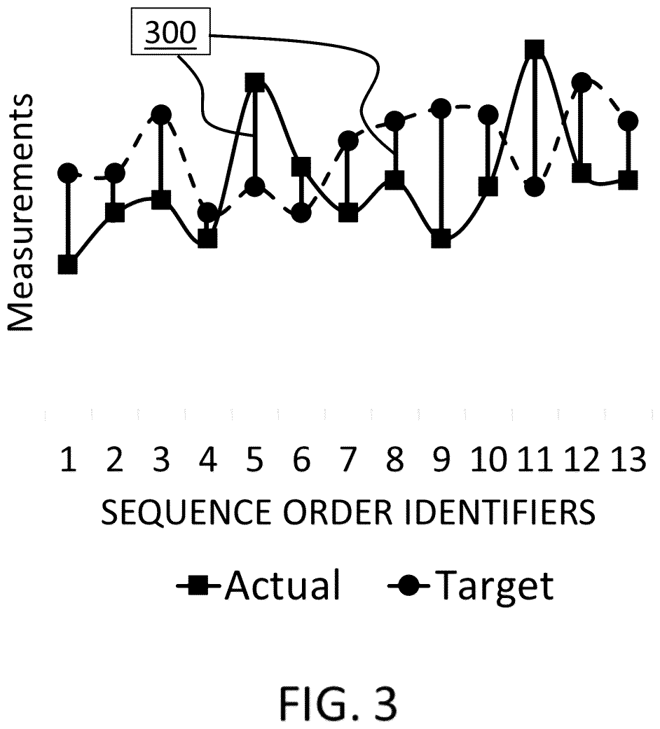

FIG. 4 represents a computer system that can receive, store, process, and transmit for display various inputs and outputs of data which can create, store, and update Data gyro bulb technology.

FIG. 5 depicts a process for creating a Data gyro bulb and an example of a graphical means of Gyro-Bulb metric assessment.

FIG. 6 is an example depiction of a graphical means for assessing multiple calculated data gyro bulb metrics at any interval of a source data stream.

FIG. 7 is a depiction of a Data gyro bulb used in practice use for a biometric measurement, monitoring, and management, such as A1C levels of an individual.

FIG. 8 is depiction of a system comprised of multiple Data gyro bulbs for use in biometric metering, monitoring, and management for A1C, blood sugar, and insulin levels.

FIG. 9 depicts four charts (900, 901, 902, 903) to illustrate the effectiveness of Data gyro bulb graphical displays. The charts reflect the sales data for two salespeople over thirteen weekly intervals.

FIG. 10 depicts processes for how data gyro bulbs can generate graphical analyses of multiple metrics through assessment criteria at each interval of a sequence. The Data gyro bulb data and analyses can be transmitted to blockchain technologies as transactions for both variable smart contract execution and performance tracking on immutable, distributed ledgers.

FIG. 11 depicts Data gyro bulb technology in the practice of managing and executing smart contracts through blockchain technology between two entities.

FIG. 12 is a prior work of art that illustrates an overview of the process for smart contracts on the Ethereum Blockchain technology.

FIG. 13 visualizes a weekly interval source data steam in the form of a table for two salespeople (A and B) over a thirteen-week sequence. Below the table are assessment means settings for a data gyro bulb. Below the settings are data gyro bulbs for both salesperson A and B at interval 13 of the source data stream sequence through the lens of the above assessment means.

FIG. 14 depicts a system for metering, monitoring, and alerting a rail system of potential avalanches and landslides and recommending actions such as delayed routes and controlled landslide activations.

FIG. 15 is an assortment of examples of graphical displays that could be generated with the data gyro bulb invention. Changes in color, size, pattern, shading, rotation, plotting of points, or creation of metric vectors can communicate the position of metrics on the graphical reference planes created by the graphics.

FIG. 16 contains further examples of graphical displays that could be generated with the data gyro bulb invention. Changes in color, size, pattern, shading, rotation, plotting of points, or creation of metric vectors can communicate the position of metrics on the graphical reference planes created by the graphics.

### DETAILED DESCRIPTION

### Definitions and Overview

Before describing the present invention in detail, it is to be understood that the invention is not limited to any particular electronic system and/or process, as such may vary. It is also to be understood that the terminology used herein is for the purpose of describing generalized and particularized embodiments only and is not intended to be limiting.

In addition, as used in this specification and the appended claims, the singular article forms “a,” “an,” and “the” include both singular and plural referents unless the context clearly dictates otherwise. Thus, a “system” may include a plurality of systems, a “process” may include a set of processes, etc.

In this specification and in the claims that follow, reference may be made to terms that shall be defined to have the following meanings, unless the context in which they are employed clearly indicates otherwise:

The term “advertisement” is used in its ordinary sense and refers to a notice or announcement in a medium accessible by one or more of a target audience promoting a product, service, or event or publicizing a want or a need by an advertiser.

The term “application” or “app” is used in its computing sense and refers to software, especially as downloaded by a user to a mobile device.

The term “artificial intelligence” or “AI” is used in its ordinary sense and refers to the ability of a digital computer, of a computer-controlled bot and/or of a system to perform tasks commonly associated with nonhuman intelligence, e.g., to process, crunch and/or compare actual and target data e.g., in terms of their values. AI is typically, but not always, associated with “smart” and/or “bot” technology.

The term “arbitrage” is used in its AI sense and refers to the substantive buying and selling of securities, currencies, and/or commodities representing real assets, tangible and/or virtual, e.g., in electronic form, in different markets or in derivative forms in order to take advantage of differing prices for the same asset. Thus, the invention may be used to arbitrage items like cryptocurrency, pork belly futures, etc.

The term “audience” is used herein in its ordinary sense, and refers to the readers, viewers, listeners, and the like of a received signal, e.g., an optical signal, an audio signal, and/or a haptic signal. The received signal may, for example, take the form of a text message, a collection of musical notes in sequence and/or mechanical vibrations detectable through touch.

The term “bot” is a term of art and refers to a substantially nonhuman machine, e.g., virtual and/or tangible, that is typically electronically manifested as a computer program and that can operate as an agent for a user or another program. Bots are often used to automate some or all tasks without specific instructions from humans, but human instructions may enhance the performance of bots so that the invention may carry out AI in a “smart” manner. Examples of bots include chatbots, which can generally communicate visually, aurally, and/or haptically. Other bots of the invention include, for example, robots, social bots, shopbots, knowbots, and spiders or crawlers, etc. Thus, recitation of the term “bot” comports with all requirements of 35 U.S.C. 101 and 35. U.S.C. 112.

The term “bulb” as in “data gyro bulb” refers to an electronic and optionally virtual item that represents the product of a data manipulating and/or comparing process using AI. In general, a bulb or a data gyro bulb allows for AI illumination of manipulated, analyzed and/or verified data in a meaningful manner, e.g., to a human and/or nonhuman user. Thus, recitation of the term “data gyro bulb” in the claims that follow renders the claims below comporting with all legal requirements of 35 U.S.C. 101 and 35 U.S.C. 112.

The term “block chain” is a term of art and refers to one or more growing lists of blocks that are securely linked together via cryptographic hashes. The term “block chains” associated with the invention may also be a subset of the term “sequential data blocks” when viewed in proper context.

For claim interpretation purposes, the transitional phrases “comprising”, “consisting essentially of” and “consisting of” may define the scope of a claim with respect to what unrecited additional components or steps, if any, are excluded from the scope of the claim. The transitional terms “comprising” and/or “comprised of,” which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s) of the claimed invention. A “consisting essentially of” claim occupies a middle ground between closed claims that are written in a “consisting of” format and fully open claims that are drafted in a “comprising” format. Additional information about transitional phrases and their interpretation may be found in MPEP 2111.03

The term “consideration” may be used in a “smart contract” context and may mean something of value given in exchange for something else of value in a smart manner that involves an offer and an acceptance.

The term “crypto” as in “cryptocurrency” refers to digital currency and or securities that are primarily managed, stored or exchanged on digital computer systems, especially over the internet, e.g., via electronic means. Cryptocurrency may have properties, attributes and/or may exhibit characteristics and/or attributes of block chains and/or data blocks technology. Other uses of the term “crypto” may involve cryptography and like technologies.

A simple example of “crypto-graphic” or “cryptographic” technology involves the generation or use of one or more files, e.g., PGP files. For example, PGP files represent the result of a standardized encryption scheme involving the use of very large prime numbers. Such very large numbers are typically stored in machines and/or memory of a non-human nature. Thus, when “crypto” is used by itself, it may refer to a patentable eligible aspect of the invention such as cryptocurrency-based inventions and or electronic cryptography.

Cryptocurrency may not exist in a purely physical form (like paper money) and is typically not issued by a central governmental authority like fiat currency. However, cryptocurrency typically is considered electronic in nature, so that recitation of the term “cryptocurrency” allows reference thereto to comport with patent eligibility requirement associated with 35 USC 101. Examples of cryptocurrencies include Bitcoin and Etherium.

The term “data” as in “data block” generally refers to facts and/or statistics collected for reference or analysis. Typically, data blocks involve quantities, characters, or symbols on which operations are performed by a computer.

The terms “distributed” and “distribution,” as in a “distributed system” are used in a computer science and/or logistical sense and refers to a system having a plurality of interconnected nodes. Thus, some distributed systems may involve a plurality of physical and/or electronic nodes that allow for the “propagation of gyroscopic propagation of data.”

The terms “electronic,” “electronically, and the like are used in their ordinary sense and related to structures, e.g., semiconductor microstructures, which provide control conduction of electrons or other charge carriers such as holes. Thus, for example, the term “electronic text message” may refer to an expression that employs letters, symbols, and/or numerals that involves controlled conduction of electrons in a digital and/or analog manner, e.g., via SMS or MMS. Similarly, the term “electronic signal” may refer to a signal that is associated with a transition of an electron's quantum state between a valence band and a conduction band, optionally having a location in a trap.

The term “electronic” thus may implicate electromagnetic phenomenon as well, e.g., phenomenon associated with microprocessors, memory storage drives (electro-magnetic, magnetic, optical) etc. Since electrons are a composition of matter, electronic matter comports with patent eligibility requirements associated with 35 U.S.C. 101.

The term “frequentative” is used in an AI and/or internet-of-things sense and generally relates to repeated, e.g., iterative, computerized processes that generally conserve computing resources, such as memory, and processing power while increasing computing speed. The term used herein is analogous to how the term is used in statistical sciences. The term may be associated with AI concerns like grammar, syntax, etc., familiar to computerized users as well as human computer programmers.

The terms “gamify” relate to how processes and systems of the invention may be viewed as games and/or gaming activities. Such games or gaming activity generally constitute form of play or sport, especially a competitive one played according to rules and decided by skill, strength, and/or luck. When used to describe a process involving a machine such as a computer, gamification may strategy and/or tactics may depend on processor speed and algorithmic agility. “Gamification” typically involves the application of typical elements of game playing (e.g., point scoring, competition with others, rules of play) to (an activity). Thus, gamification, as discussed below, may involve an online marketing technique to encourage engagement with a product or service.

The term “genesis” as in “genesis data block” is used as a term of art in an AI data processing context and refers to the origin or mode of formation of a data block sequence.

The term or prefix “gyro” is used as a term of art and is used in an analogous manner relative to how the term “gyro-scope” or “gyroscopic” is applied to machines and compositions of manner. The term gyro, when associated with compositions of matter, may involve subatomic particles such as electrons, protons, neutrons, neutrinos, quarks, leptons, boson, etc. Such subatomic particles may have positive or negative spin and tilt associated with angular momentum regardless of whether such items are considered under particle or waveform in character. In some instances, photons and photonic technology may be involved in gyro-technology.

When associated with machines, the term or prefix “gyro” may involve quantum computing technologies. It should be apparent to artisans of ordinary skill in the art as to the meaning of the term “gyro” or of the prefix “gyro-” may depending on context of usage but should always be construed as consistent with the legal requirements of 35 U.S.C. 101 and 35 U.S.C. 112.

The term “individual” is used herein in its ordinary sense and generally refers to a single human being as distinct from a group, class, or family. In contrast, the term “party” refers to a person or people forming a gathering. The gathering may be a legal entity such as a corporation, a partnership, a limited liability company, etc. However, in a more specific usage, “individual” machines may exhibit human-like behavior but are generally considered nonhuman in nature. Thus, constructive of legal interpretation of the term “individual” is generally considered definite depending on context of usage.

The terms “informatic” and “informatics” are used in their ordinary sense and refer generally to the science of processing data for storage and retrieval in an information science context.

The term “internet” is used herein in its ordinary sense and refers to an interconnected system of networks that connects computers around the world via the TCP/IP and/or other protocols. Unless the context of its usage clearly indicates otherwise, the term “web” is generally used in a synonymous manner with the term “internet.”

The terms “iteration” and “iterative” are used in a computer science sense and mean relating to or involving iteration, especially of a computational process, an architecture, and/or an electronic structure associated with AI, in general contrast to recursive or recursion processes and structures, though recursive elements may be involved.

The term “machine” is used in its ordinary 35. U.S.C 101 sense and refers to an apparatus using or applying electronic force or power and having several parts, each with a definite function and together performing a particular task and/or process.

The terms “node” and “nodal” are generally used in a computing sense and are used to refer to one or more points, pathways, and/or paths that may intersect and/or branch. Certain points may be considered central to connecting points in a spoke-and-hub manner. Node and nodal technologies thus may form a connected web or network to form a neural nodal network system suitable for AI applications.

The term “object” is used in its ordinary AI and/or informatic sense and refers to a thing that may be virtually generated, e.g., by a computer, so that it may be manipulated by a user.

The terms “optional” and “optionally,” as used herein, refer to referents that follow the term(s) existent or nonexistent. Thus, when the invention is embodied in a form that includes an optional element, the element may or may not be present depending on situational usage of the term(s).

The terms “pay” and “payment” are used in their ordinary sense and refer to the act of paying, compensating, remunerating, satisfying, reimbursing, and/or give money or its equivalent (such as cryptocurrency, vendor credit, etc.) in return for something so that an obligation incurred by a payer, e.g., a third party sending an advertisement with an accompanying text message sent by a first party to a second party, is discharged. The term is of relevance and materiality in the context of “smart” contracts.

The term “process” is used in its ordinary sense and should be interpreted in a broadest reasonable manner such that it comports with 35 U.S.C. 101.

The term “quantum” as in “quantum computing” refers to technology involving a discrete quantity of energy proportional in magnitude to the frequency of the radiation it represents. “Quantum” computers therefore operate in an analogous manner relying on discrete amount of any other physical quantity, such as momentum or electric charge. Thus, “quantum computing” is used herein in its ordinary sense to refer to computing that makes use of the quantum states of subatomic particles to store information.

The terms “sequence” and “sequential” are used in their ordinary sense, referring to a particular order in which related events, movements, or things follow each other, typically over the passage of time.

The term “smart” as in “smart machine,” “smart agent,” or “smart device,” is used in a term-of-art manner and refers, e.g., to machines, e.g., computer processors, virtual machine, or the like, programmed to be at least capable of some independent action from a user, e.g., a human and/or nonhuman user. Thus, for example, the term “smart device” is used herein to refer to an electronic device, generally connected to other devices or networks via different wireless protocols such as Bluetooth, NFC, Wi-Fi, 3G, 4G, 5G, 10G, etc., that can operate to some extent interactively and autonomously. Exemplary smart devices include smart phones, tablets, handhelds, etc.

Usage of the term of art “state,” herein, typically involves a computer science and/or information technology usage context. A system or a process is described as stateful if it is designed to remember preceding events or user interactions; the remembered information is called the state of the system.

The set of states a system can occupy is known as its state space. In a discrete, quantized and/or digital system, the state space is countable and often finite. However, a practically infinite space may be achieved when memory and processor speed are sufficiently large and fast, respectively. The system's internal behavior or interaction with its environment consists of separately occurring individual actions or events, such as accepting input or producing output, that may or may not cause the system to change its state. Examples of such systems include digital logic circuits and components, automata and formal language, computer programs, and computers.

While the output of a digital circuit or a deterministic computer program at any time is typically completely determined by its current inputs and its state. Random and/or stochastic techniques may be used in conjunction with AI technology in stateful computer systems.

The term “stochastic” is used herein to mean randomly determined. In general, stochastic events exhibit a random probability distribution or pattern that may be analyzed statistically but may not be predicted precisely. Thus, the term may involve one or more different types of statistical and/or probabilistic techniques, e.g., Monte Carlo simulation methods, Monte Carlos algorithms, such as the Karger-Stein algorithm, the Monte Carlo algorithm for minimum feedback arc set, etc. Thus, stochastic processes may exhibit ordered, e.g., gaussian (bell curve, Student-T curve, and or the like), and/or disordered, e.g., entropic, properties.

The terms “substantial” and “substantially,” as used to describe a plurality of items having positive or negative qualities, are used to indicate that the items are to considerable degree, positive or negative. For example, a substantially positive item is not merely trivially positive but is considerably deviated from zero. Similarly, a substantially negative item is not merely a little bit smaller than zero but is considerably smaller than zero when viewed in proper context.

Thus, the term “substantially instantaneous” is used to refer to one or more events that to a considerable degree occur or are completed with no delay, but that the absolute absence of any delay is not required.

In any case, the terms “substantial” and “substantially” are used analogously in other contexts involving an analogous definition.

The term “supply” as in “supply chain” is used in its ordinary sense and refers to assets, typically electronic in characteristic and/or representation, involving one or more sequences of processes involved in the production and distribution of a commodity and/or service.

The terms “system” and “systematic” are used in their ordinary AI sense and refers to a set of things working together as parts of a mechanism and/or an interconnecting network operating as a process or method in an organized and/or structural framework, e.g., involving a plurality of nodes.

The term “target” as in “target value” is used to refer to an ideal, desired, or expected value, to be achieved without substantial positive or negative deviation from the ideal, desired, or expected value. Target values, for example, may depend partially or fully on factors associated with individualized “actual” measurement values and/or on standards that may evolve over time.

The term “text message” is used in its ordinary sense and refers typically to an electronic communication sent and received by a mobile communication means wherein at least one of the sending and receiving means has a telephonic capability. Often, text messages are a form of a short message service (SMS), a method of communication that sends text in the form of letters, symbols, and/or numerals, between cell phones, or from a personal computer or handheld to a cell phone. The “short” part refers to the maximum size of the text messages, which may include 160 characters (letters, numbers or symbols in the Latin alphabet). For other alphabets, such as Chinese, the maximum SMS size may be 70 characters.

The term “text message” may also extend beyond alphanumeric text to include multimedia messages using the multimedia message service (MMS) containing digital images, videos, and sound content, as well as ideograms known as emoji (happy faces, sad faces, and other icons). Text messages are typically generated through instant messenger applications (usually the term is used when on mobile devices).

The term “token” and “tokenize” refers to datum or data that represent an electronic depiction of a cryptographic item such as cryptocurrency. In some instances, the term token may refer to one or more electronic “cookies” serving as one or more data files that may be stored on one or more electronic devices or systems and/or nodes thereof.

The term “user” refers to a human, human-like or non-human entity that operates something or operates on something, especially a computer, other machine, or system of the invention.

The term “vector” is used in a term of art manner associated with an ordinary mathematical/physics context, and refers to a quantity having direction as well as magnitude, especially as determining the position of one point in space relative to another, particular in graphical object representation. However, the term “vector” may be used in a biological, healthcare, and/or medical sense. For example, mosquitos and ticks may carry bacterial and/or viral agents that may cause human disease. Thus, depending on usage in the specification, herein, and/or claims, that follows, the term vector should be interpreted in a smart, human, and/or humanistic manner.

The term “Web 3.0” is a term of art and refers to a “semantic web” which is an extension of the World Wide Web (www) through standards set by the World Wide Web Consortium. The goal of Web 3.0 is to make internet data machine-readable. A closely related term is “Web3,” which is a new iteration of www that incorporates, e.g., decentralization or distributed nodal technologies, blockchain technologies, and token-based methods, e.g., those associated with cryptocurrency. Unless the context of usage clearly dictates otherwise, “Web 3.0” and “Web3” should be considered synonyms for interpreting the contents contained herein.

Thus, the term “web” is used in its ordinary sense and refers to a complex system of interconnected elements like websites (and associated hyperlinks), nodes, etc. To the extent that the term “web” refers to any illegal associated with the so-called “dark web,” such illegality is hereby disclaimed for all legal/jurisdictional purposes.

The term “zero gap is a term of art that is to be interpreted in a generalized sense of precision between an actual measurement and target measurement, where there is no measurable difference. The term “zero gap trend” (zero trend) is a term of art that is to be interpreted in a generalized sense of having no change in the difference between the actual and target measurement, the difference being zero or otherwise. Additional disclosure pertaining to “zero gap” and “zero gap trend” is discussed below; thus, recitation of the terms zero gap and/or zero gap trend allows claims that follow to comport with the requirements for patentability as set forth by 35 U.S.C 101 and 35 U.S.C. 112, and all subsections thereof.

Thus, in general, the invention relates to data gyro bulb technology. Such technology finds usefulness in illuminating and analyzing differences between a metric and a target over sequences. An important aspects of data gyro bulb technology pertains to zero gaps and zero trends. Zero data gaps generally represent a precisely idealized or predetermined situation between actual values and target values. Zero data trends generally represent a precisely stable situation where the data gap has not changed over intervals or sequences. In other words, zero trends may represent no change in a data gap, zero or otherwise. In any case, the invention may involve massive amounts of data, involving terabytes of memory, supercomputing processing speed, and distributed displays involving dashboards that may be whole, partially shared, in a segregated or desegregated manner (e.g., via many different located around the United States and around the world).

Data gyro bulb technology has applications in many fields and may be expressed in different embodied forms. A plurality of inventive embodiments with different uses/usages/usefulness is described below.

For example, as a first embodiment, an electronic informatics system is provided. The system comprises: a sequential data stream of data blocks, wherein the stream of data blocks comprises a genesis data block, and each data block of the stream of data blocks includes a sequence order identifier, an actual value, and a target value; a set of metrics that each includes one or more metric components selected from a gap or a trend metric at current intervals or over sequences of intervals, generating a current gap, a current trend, a cumulative gap, and a cumulative trend; a calculating means for calculating a derivative metric at each of the data blocks; and a derivative assessing means for assessing derivative metrics relative to zero. The system operates in a manner that is consistent with a zero value that is neither substantially positive nor substantially negative representing a precisely ideal or predetermined state or a completely stable state between the actual value and the target value.

In a second embodiment, the invention provides frequentative electronic data processing using a processor and a memory adapted to carry out informatics. Such processing and/or processes comprise: providing an electronically executable program stored at least partially in the memory and configured to be executed by the processor; receiving a sequential data stream of data blocks, wherein the stream of data blocks includes a genesis data block, and each data block of the stream of data blocks includes a sequence order identifier, an actual measurement, and a target measurement; calculating derivative metrics of the sequential data stream for each of the data blocks, wherein the derivative metrics each includes at least one of a current gap, a current trend, a cumulative gap, and a cumulative trend; and generating a data gyro bulb to facilitate a zero gap and trend between actual data measurements and target data measurements.

In a further embodiment, provided is an AI generated data gyro bulb and an associated zero gap that is neither substantially positive nor substantially negative representing an ideal state between an actual measured value and a target measured value. Such technology comprises: an electronic computer-implemented data processor for carrying out a method for affecting and/or effecting informatic practices. The method comprises providing an electronically executable program stored at least partially in the memory and configured to be executed by the processor, receiving a sequential data stream of data blocks, wherein the stream of data blocks includes a genesis data block, and each data block of the stream of data blocks includes a sequence order identifier, an actual measurement, and a target measurement, calculating derivative metrics of the sequential data stream for each of the data blocks, wherein the derivative metrics are comprised of a gap or a trend at current intervals or cumulatively over sequences and includes at least one of a current gap, a current trend, a cumulative gap, and a cumulative trend, and the calculated derivative metrics are interpreted via an assessment means consistent with zero at each of the data blocks.

As generally alluded to above, informatics and/or AI technologies are used. Thus, for example, the inventive system may operate via gyro, bot, and/or adjustment technology to carry out data processing to produce a data gyro bulb. The data gyro bulb may, thus, exhibit human-like and/or smart properties, characteristics and/or attributes. In addition, informatics and/or AI technologies may involve tokenization of calculated derivative data on Web 3.0 decentralized networks with cryptographic communication protocols and creates and distributes cryptocurrencies, as discussed in detail, infra.

Output of basic embodiments of the invention may be electronically communicated or transmitted to a display, speaker, and/or another physical device. For example, the electronic informatics system of the invention may comprise a display that displays an object, e.g., an electronic object, which represents at least an aspect of the inventive data gyro bulb. The display may operate visually, aurally, electronically and/or photonically, to serve as a means for transmitting a signal, e.g., to a user.

Bio/Heath/Medical/Medicinal Applications

The invention has applicability in biological based, healthcare, medical, and/or medicinal context. For example, the invention may employ systematic instructions for alerting and directing care for a diabetic individual. The systematic instructions may direct care for the diabetic individual based on an actual measured value for blood glucose and a target value for blood glucose of the individual. The systematic instructions include and/or incorporate actual and target A1C values, i.e., glycated hemoglobin values for the individual.

Numerous factors may affect blood glucose and/or A1C values for subjects and/or patients presenting with diabetes. Thus, systematic instructions for this embodiment of the invention may include and/or incorporate data representing exercise data and/or history of the individual, and/or diet history of the individual. For example, such data may include sugar intake of the individual, sugar alcohol intake of the individual, and/or artificial sweetener intake of the individual wherein the artificial sweetener may be associated with an extremely low glycemic index value.

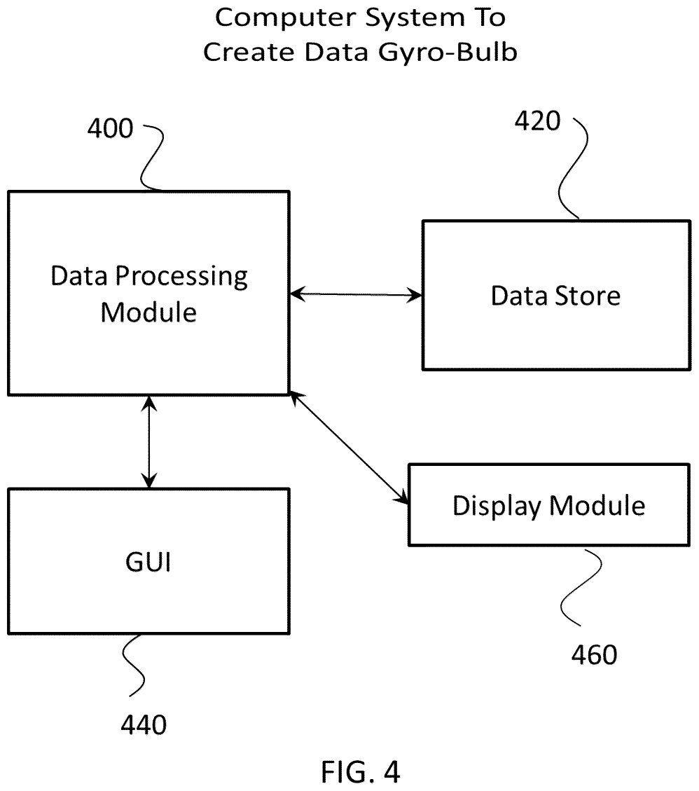

FIG. 4 depicts a computer system that may be used to create a data gyro bulb. As shown, a data processing module 400 is provided. The module may be interfaced with data store 420, graphical user interface (GUI) 440, and a display module 460.

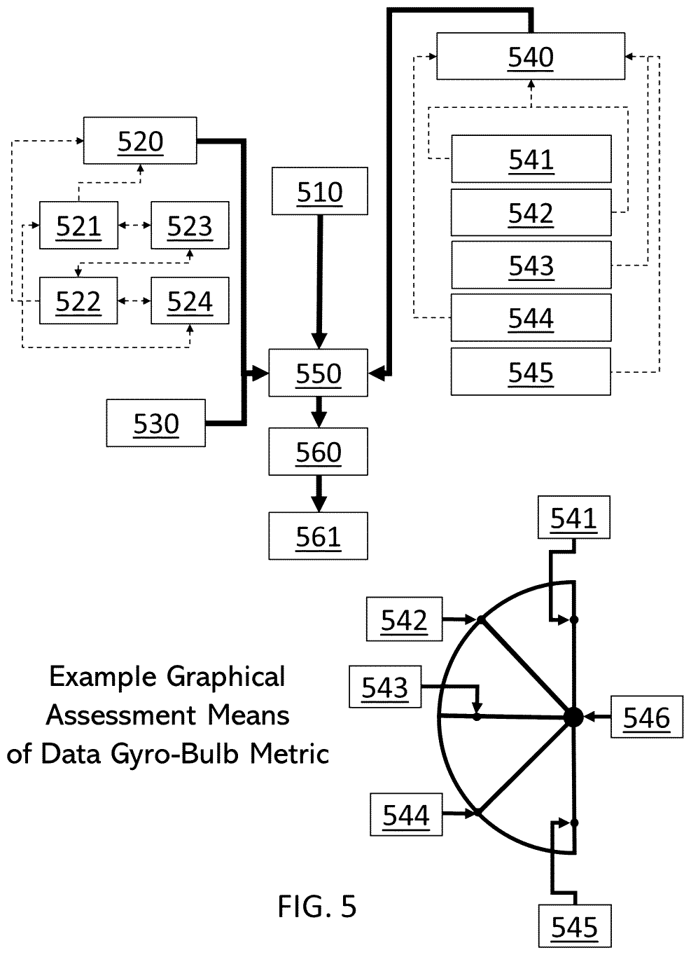

FIG. 5 illustrates the general components and processes for generating a data gyro bulb. 510 represents a data gyro bulb source data stream comprised of a data stream of at least one sequence of data intervals wherein each interval, or data block, is comprised of a sequence order identifier, an actual metric measurement, and a target metric measurement. The 510 data stream is received by the data gyro bulb at element 550. 520 represents the means for composing current gap(s), current trend(s), cumulative gap(s), and cumulative trend(s) from the source data streams of 510 and transmitting the composition methods to data gyro bulb 550. 521 represents the means for current interval sequencing, 522 is the means for cumulative sequencing, 523 a means for composing a gap between the actual and target measurements, and 524 a means for composing a trend of the gap. These elements produce at least one of a current gap, current trend, cumulative gap, or cumulative trend. 530 represents the means for calculating metrics composed from element 520. 540 is the assessment means for the metrics composed from 520 and calculated 530 in the data gyro bulb 550 from the source data stream of 510. The elements of assessment may vary in optionality but are generally composed of ranges and scales greater than and less than a zero-point value, wherein a zero point for a calculated metric represents a precisely targeted predetermined state of no gap or a precisely stable state of no trend, or change, in the gap relative to current interval or cumulative interval sequencing. 541 is a means for establishing a maximum limit, which may be a natural, real, integer, decimal, float, or imaginary number value or could also be established as the concept of cardinal or ordinal infinity. 542 is a means for establishing upper range limits between zero and a maximum limit. 543 is an established zero-point to indicate a calculated data gyro bulb metric is not measurably positive or not measurably negative. 544 is a means for establishing lower range limits less than zero and greater than a minimum limit. 545 is a means of establishing a minimum limit, which may generally be negative real, imaginary, integer, decimal, float, or imaginary numbers, and could also be set to the concept of cardinal or ordinal negative infinity. Assessment ranges and scales may be applied relative to concepts such as standard deviation, standardized, and normalized data. These are examples of assessment means (540) parameter options that comprise an architecture to interpret and model the data gyro bulb calculated metrics (520, 530) derived from source data streams (510). 560 represents modules to receive data gyro bulb interval metrics (data blocks) and to conduct data, graphical, language, text, audio, and other modeling to render descriptive, predictive, and prescriptive alerts, insights, and recommendations ready for display. 561 represents display modules capable of receiving and displaying the data gyro bulb data and the modeled outputs from 560. Element 546 represents a example graphical object representation of assessment means parameters for a data gyro bulb metric as set forth in module 540 with components 541, 542, 543, 544, 545. This graphical structure can be utilized represent data gyro bulb values through changes to color, pattern, shading, plotting of points, change of size, creation of vectors from the origin to plotted points of interest, rotations, and other graphical modification that may change over selected intervals or animated over sequences generated by the composed and calculated data gyro bulb metrics.

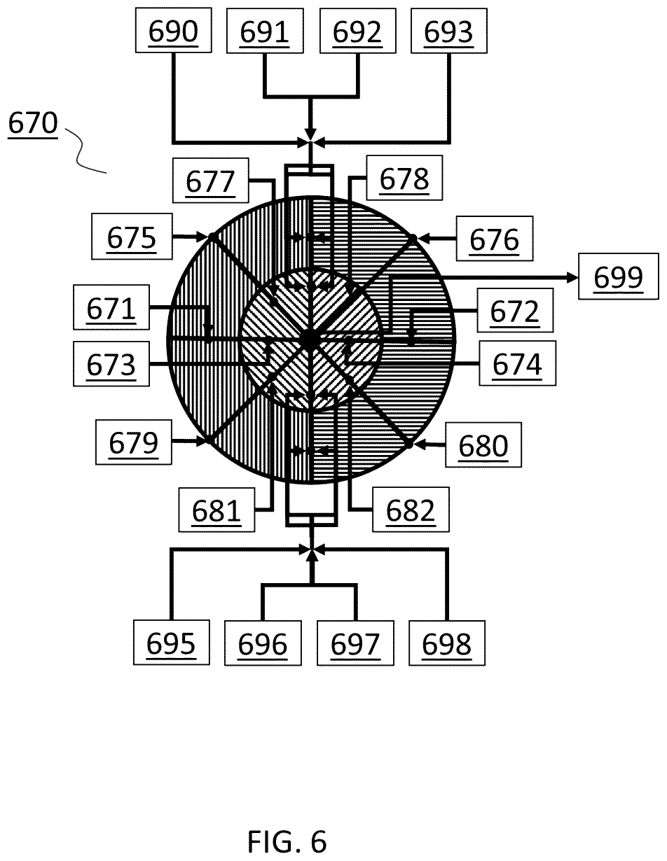

In FIG. 6, item 670 represents an example of a graphical object that is used to display the assessment means of four data gyro bulb metrics at selected intervals or animated over sequences of the composed and calculated metrics. 699 represents an origin point that acts as a reference for the parameters of four areas bifurcated twice by horizon lines representing maximum and minimum positions and zero points representing zero gaps and zero trends. The four areas are further segmented by upper and lower limit positions within each of their areas. As an example, the following could be true; the outer left side in vertical line shading represents a graphical reference plane to represent a calculated current gap metric, the outer right side in horizontal line shading represents a graphical reference plane to represent a calculated current trend metric, the inner left side with angular shading in the upward left direction represents a graphical reference plane to represent a calculated cumulative gap) metric, and the inner right side with angular shading in the upward right direction represents a graphical reference plane to represent a calculated cumulative trend metric. This graphical representation can be extended further to render summary analyses in the form of text, data, graphics, sound, or other electronic means by which to simulate and parallel process multiple scenarios through Artificial Intelligence to determine predicted optimal scenarios in reducing variance and volatility of the variance between a metric and its targets, or to elicit required actions to avoid undesired consequences as the result of gap and trends between metrics and their targets. Changes to shading, patterns, rotations, plotting points of interest with vectors, or other alterations to the graphical reference planes can be used to indicate and animate the values of the calculated data gyro bulb metrics at intervals and over sequences. Each data gyro bulb interval's graphical representations produce a form of graphical analysis of the sequence to that interval and animations over intervals produce sequential patterns for added data gyro bulb analyses and interpretations. To provide a detailed outline of a basic data gyro bulb assessment architecture graphical embodiment for the derivative metrics, the following elements are defined as 677 represents a zero-point line position for a calculated current gap metric. 672 represents a zero-point line position for a calculated current trend metric. 673 represents a zero-point line position for a calculated cumulative gap metric. 674 represents a zero-point line position for a calculated cumulative trend metric. 675 represents an upper range limit line position for a calculated current gap metric. 676 represents an upper range limit line position for a calculated current trend metric. 677 represents an upper range limit line position for a calculated cumulative gap metric. 678 represents an upper range limit line position for a calculated cumulative trend metric. 679 represents a lower range limit line position for a calculated current gap metric. 680 represents a lower range limit line position for a calculated current trend metric. 681 represents a lower range limit line position for a calculated cumulative gap metric. 682 represents a lower range limit line position for a calculated cumulative trend metric. 690 represents the maximum limit line position for a calculated current gap metric. 691 represents the maximum limit line position for a calculated current trend metric. 692 represents the maximum limit line position for a calculated cumulative gap metric. 693 represents a maximum limit line position for a calculated cumulative trend metric. 695 represents the minimum limit line position for a calculated current gap metric. 696 represents a minimum limit line position for a calculated current trend metric. 697 represents a minimum limit line position for a calculated cumulative gap metric. 698 represents a minimum limit line position for a calculated cumulative trend metric. 699 represents an origin point around which to orient the graphical reference planes.

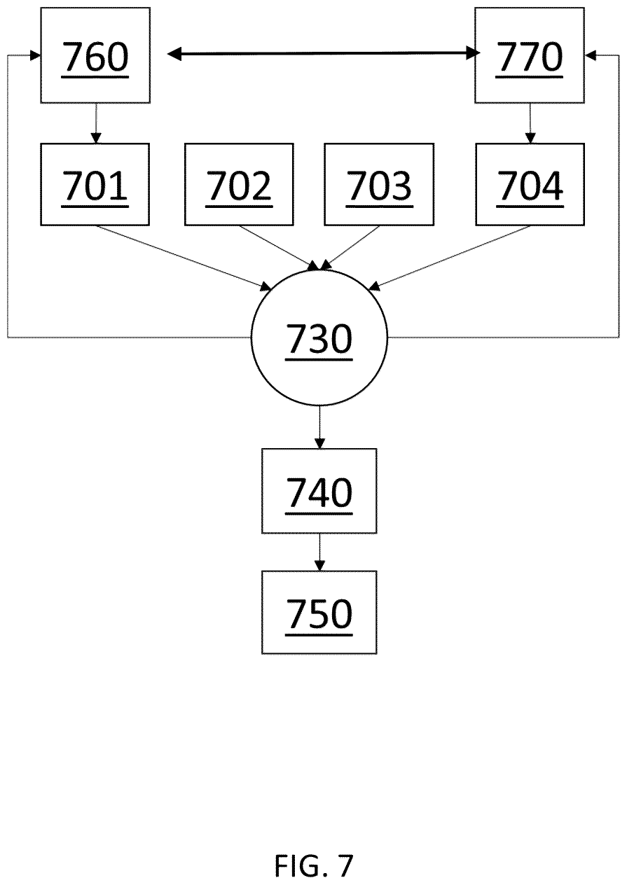

FIG. 7 is a flow chart depicting the practice of the invention in a biometric context. As shown, a biometric data stream 701 is provided. The data stream 701 may comprise data blocks that each include: (A) a sequence order identifier (which may be expressed as a time interval); (B) a metric target measurement at each interval; and (C) a metric actual measurement at each interval. 702 represents the composition of derivative metrics generated in the data gyro bulb from the biometric data stream of element 701. These metrics are one or more of a current gap(s), current trend(s), cumulative gap(s), and cumulative trend(s). 703 represents the means of calculating the composed derivative metrics. Element 704 represents an assessment means for interpretation of the derived metrics in the form consistent with zero and of ranges and limits. 704 and can be determined from data stream 701 or set independently. Then, data gyro bulb 730 technology is used in conjunction with data stream 701, the metric compositions of 702, the calculation means of 703, and the assessment means of ranges and limits from 704 determined therefrom.

From the data gyro bulb, target adjustment models 760 may be produced. As a result, the output from the models 760 may serve as a recursive feedback mechanism to adjust data stream 701.

Similarly, range and limit adjustment models 770 may be produced. The output from models 770 may serve as a recursive feedback mechanism to adjust ranges and limits 704.

Also produced as output from the data gyro bulb 730 are alerts, language translation, recommendation model and algorithms 740. In an ideal situation, there may be a zero gap state between the metric target measurement and a metric actual measurement at each interval. However, recommendations for future targets and the means as how to achieve a zero gap and zero trend states may be displayed at display interface 750, regardless as to whether a zero gap state or deviations therefrom is occurring during the practice of the invention.

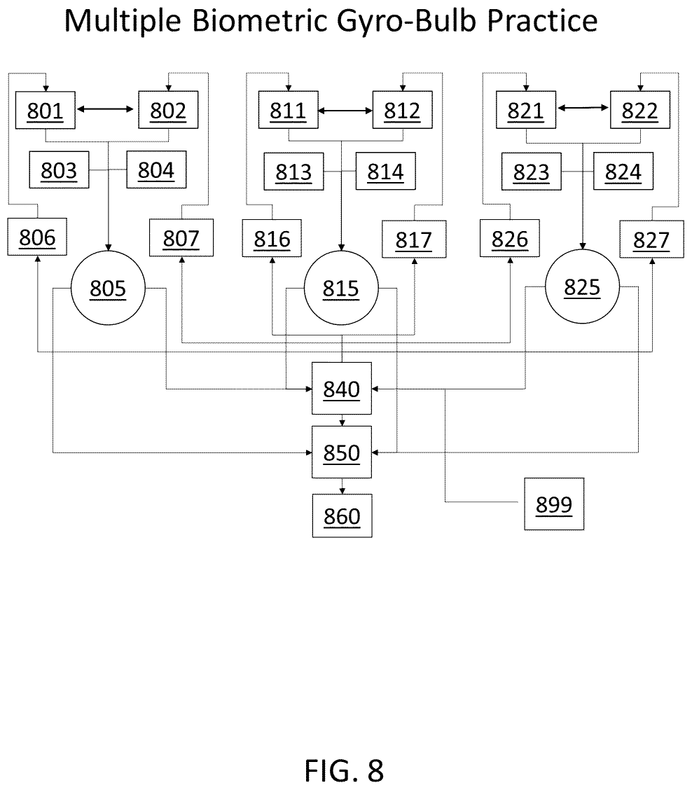

FIG. 8 is a flow chart depicting how biometric data pertaining to diabetes management may be accomplished via the generation of at least three distinct yet related data gyro bulbs 805, 815, 825. An A1C data stream 801 is associated with 802 data gyro bulb assessment means of ranges and limits, 803 composes the derivative metric interval and sequencing of current and cumulative gaps and trends for the 805 A1C data gyro bulb, 804 comprises calculation means for A1C data gyro bulb derivatives, target adjustment models 806, and assessment means range and limit adjustment models 807. A blood sugar data stream 811 is associated with ranges and limits 812, derivative metric composition models 813, and derivative calculation models 814 to supply the function of data gyro bulb 815, target adjustment models 816, and assessment means range and limit adjustment models 817. An insulin data stream 821 is associated with assessment means ranges and limits 822, derivative metric composition model 823, and derivative metric calculation model 824 to supply the function of data gyro bulb 825, target adjustment models 826, and assessment means range and limit adjustment models 827.

Data gyro bulbs 805, 815, 825 operate together to effect integrated multi-variate modeling and forecasting of biometric targets, ranges and limits modeling 840. This modeling supplies the data gyro bulb's target adjustment and assessment means range and limits models of 806, 807, 816, 817, 826, and 827. Module 899 may contain further data sets and modeled outputs to supply the modeling in 840 to increase accuracy or efficacy of results. As a result, alerts, language translations, recommendation models and algorithms 850 are produced. Finally, the practice of the invention results in processed data gyro bulbs output displayed at the display interface 860.

In any case, embodiments of the invention may involve electronic informatics systems that use systematic instructions that include and/or incorporate data representing overall health of the individual. The systematic instructions may include and/or incorporate data representing, blood pressure, heart rate, sleep pattern, sleep habit, exercise pattern, exercise habit, diet pattern, diet habit, physical activity, activity intensity, pharmacological information, and/or nutritional information.

As a result, the invention may be used in conjunction with public health metrics. For example, the invention may be associated with instructions for receiving and displaying public health metrics. Thus, the inventive system may be used to carry out identification, alerting, and direction of users, nodal or other sub-systemic machines prioritize actions and resources to manage desired individualized and/or public health outcomes. For example, the invention may be useful in carrying out resource management and/or alerting the public to outbreaks associated with infectious diseases like Covid-19, influenza, etc. Source data streams such as available hospital resources, medication and vaccines, staffing, and infection rates across various population cohorts maybe devised and modeled deploying the data gyro bulb processes and architectures to help predict outcomes and advise recommended actions to affect public health results.

Web 3.0 and/or Smart Applications Involving Electronic Processes

The invention also has applicability in Web 3.0 and/or smart technology fields of endeavor. For example, the invention provides an electronic process allowing for frequentative data processing using a processor and a memory adapted to carry out informatics. For example, the process may involve the following required and/or optional steps: providing an electronically executable program stored at least partially in the memory and configured to be executed by the processor; receiving a sequential data stream of data blocks, wherein the stream of data blocks includes a genesis data block, and each data block of the stream of data blocks includes a sequence order identifier, an actual measurement, and a target measurement; calculating derivative metrics of the sequential data stream for each of the data blocks, wherein the derivative metrics each includes at least one of a current gap, a current trend, a cumulative gap, and a cumulative trend; and generating a data gyro bulb to facilitate a zero gap between actual data measurements and target data measurements.

The invention process may be practiced to effect one or more smart contracts. When advanced smart technologies are employed, systematic instructions for creating one or more smart contracts, which may be executable between different entities and/or system nodes. That is, for example, a plurality of linked computers may allow different entities to communicate and optionally and generate one or more cryptocurrencies from tokenized metric data. Smart contracts may also provide one or more payment terms that are variable and dependent on the one or more derivative metrics relative to associated reference vectors, ranges and scales, at predetermined contractual intervals of the sequential data stream. Thus, calculated derivative data of the contract is tokenized on Web 3.0 decentralized networks with cryptographic communication protocols, thereby creating and distributing one or more forms of cryptocurrency. In turn, one or more forms of cryptocurrency may further act as further smart contracts to the rights for future payments to holders of units of the cryptocurrency, irrespective of cryptocurrency form.

The inventive electronic process may be used for logistics purposes in a tangible sense and or in a web sense. wherein the process is carried out to control, monitor and/or improve web traffic. Since objects in a web sense is often tied to physical world, e.g., via delivery servers such as the U.S. Postal Service, United Parcel Service, FedEx, etc., the invention may provide a user with actionable information pertaining to packages, goods, services, etc. that are of use to the user and/or other members of an audience associated with the process.

In any case, the informatics processes and systems of the invention may be used in a manner to carry out and/or monitor one or more smart contracts.

The invention is particularly suited for arbitrage purposes. Arbitrage, as set forth above, is basically a technical practice that may be used in supply chain management and optimization. Traditionally, arbitrage is considered an investment strategy in which an investor simultaneously buys and sells an asset in different markets to take advantage of a price difference and generate a profit. While price differences are typically small and short-lived, the returns can be impressive when multiplied by a large volume. However, the inventive systems and processes may be used as a means for managing markets and supply chains to make sure that substantially all demand for a commodity or other tangible good/service may meet all demand in a timely manner. The invention may thus involve both arbitrage and cryptocurrency techniques associated with smart contracts. As a result, a human or nonhuman user may benefit from such smart technology.

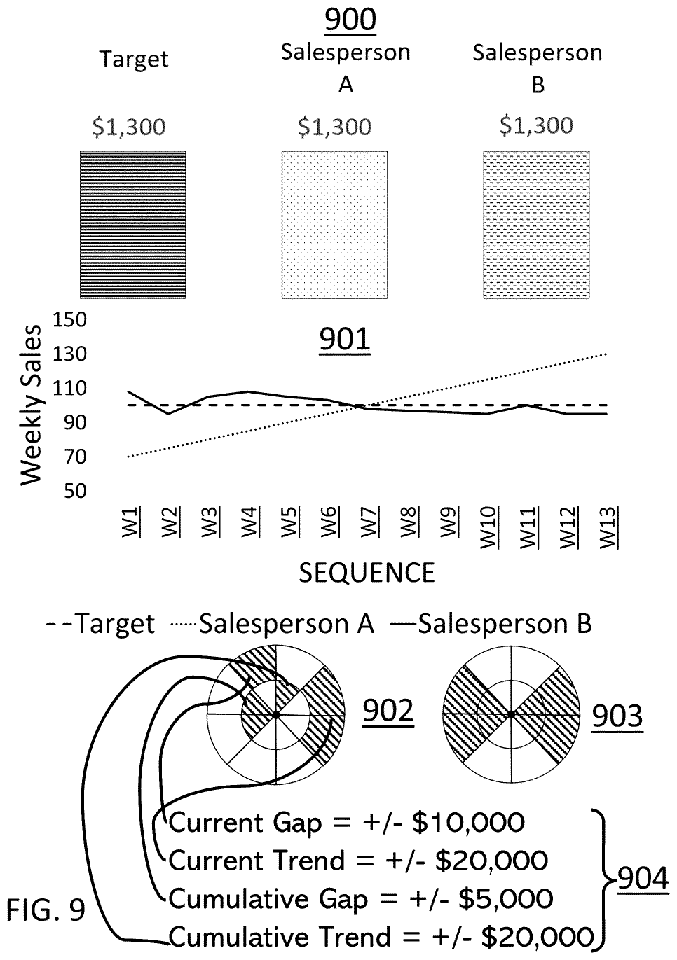

FIG. 9 illustrates simple and generalized views of basic data gyro bulb graphical embodiments of interval thirteen from elements of the data sequence as shown in line chart 901, which represents weekly sales numbers for salesperson A and salesperson B, as well as a weekly interval targets of $100. FIG. 9 shows a column chart 900 that summarizes the thirteen-week totals of the target (for each salesperson), salesperson A actual sales, and salesperson B actual sales. As can be seen by this chart, at the end of the thirteen-week sequence, each salesperson has zero gap to the target for the cumulative sequence. As shown in FIGS. 9, 902 and 903, a data gyro bulb may be created by receiving the source data stream comprised of the target values, actual values, and a graphical display can be generated through an assessment means of ranges to describe the source data streams at the intervals, and in this case the last interval of the source data stream for each salesperson. The source data stream may be put through an analytical framework that creates metrics. In this case a current gap, current trend, cumulative gap, and cumulative trend are created. Each metric is calculated and processed through algorithms to provide assessments through insights architectures which are established by the ranges as shown in 904. 902 represents salesperson A's data gyro bulb graphical embodiment at interval thirteen and can be quickly interpreted to communicate that Salesperson A is currently above target but stable and cumulatively on target and increasing, relative to zero gap and zero trend through the lens of the assessment means as established in 904. 903 represents salesperson B's data gyro bulb graphical embodiment at interval thirteen and can be quickly interpreted to communicate that Salesperson B is currently and cumulatively on-target and stable, relative to zero gap and zero trend through the lens of the assessment means as established in 904. Changes to the target values, actual values, sequence ordering, and or the assessment means can and often will create different interpretations and insights. Not all of these are readily apparent through either or both charts 900 and 901. These traditional charting methods lack the ability to contextualize the actual values at intervals and over sequences relative to a zero gap and zero trend in schema of an assessment means that produces an insights architecture for interpretation. More detailed outputs and statistical modeling of the specific gaps and trends over sequences generate increasingly valuable analytics, insights, and recommendations. This example simply illustrates at a basic level the power of the data gyro bulb technology processes and structure to create informatics and power AI processes.

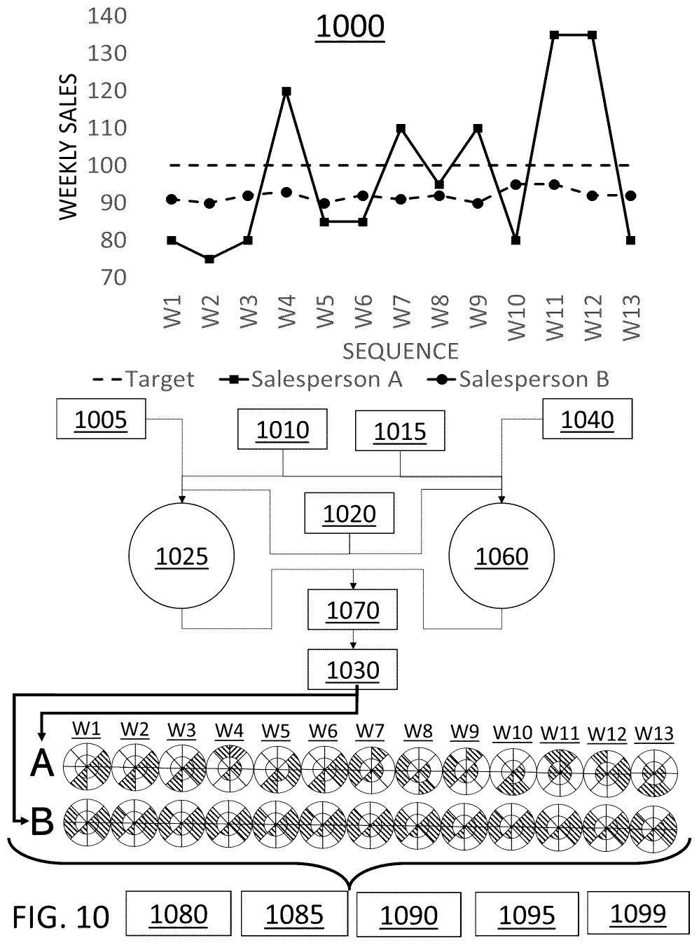

FIG. 10 provides another line chart 1000 with a sequence of thirteen weekly data intervals comprised of sales target values for each week (per salesperson), salesperson A's actual weekly sales measurements, and salesperson B's actual weekly sales measurements. Source data streams from the data of this line chart can be created and received at 1005 for salesperson A's data gyro bulb 1025 and at source data streams received at 1040 for salesperson B's data gyro bulb 1060. Data gyro bulbs 1025 and 1060 can then utilize the same contracted terms through the modules for metric composition 1010, means of metric calculations 1015, and means of assessment 1020. The data gyro bulbs may then pass data to modules for modeling displays such as graphics, alerts, language, and production of insights, predictions, and recommendations s in modules at 1070, which can then pass the data to display interfaces and blockchain technologies at 1030.

Below element 1030 are examples of data gyro bulb data block graphical displays that can be interpreted for analyses. While all thirteen are displayed for each salesperson A and salesperson B, the same graphical construct is utilized across blocks. One data gyro bulb graphic and can be updated or animated across the sequences. The general and specific patterns created by the data gyro bulb metric across the ordinal data blocks and through the assessment architecture create both insights and structure AI probabilistic scenario building to optimize and reduce the gaps and volatility of the gaps between actual and target measurements.

One example of a non-readily available insight would be that at interval eleven, Salesperson A achieved cumulative gap within a cumulative gap range of +/−5%. Another insight is that salesperson B was currently on target and stable at each interval but was also cumulatively below a cumulative gap range +/−5% at each interval. These insights can be utilized to alert and advise the salespeople and the business as to the sales performance and recommended actions to adjust activities and align actual sales with target sales measurements.

Further, the data and even the graphical displays can be tokenized on a blockchain. 1080 represents modules for applications for self-executing smart contracts that run as programmed without any chances of fraud, censorship, or third-party interference. At 1085 contract code can be translated to code will end up on a blockchain and the code needed for the transaction of placing that code on a blockchain and initializing the smart contract (running a constructor). This often includes encryption by processing the data through a “hash” function and placing it on a blockchain ledger system (often on decentralized ledger technologies). 1090 represents the execution of smart contract terms and variable payments, as set forth in a smart contract, by through predefined variable payment algorithms over each defined interval and cumulatively across sequences, utilizing the composed and calculated metrics predefined from 1010 and 1015 and the assessment criteria from 1020. 1095 releases and transfer of payments to connected financial accounts or digital wallets and/or creation and distribution of non-fungible tokens. Element 1099 represents the posting and potential distribution of non-fungible tokenized data.

The data gyro bulb composed and calculated metrics in conjunction with the means of assessment invoked on a blockchain transaction can serve as variable “proof of work” and as records of performance relative to, and as allowable by, contracted terms. These immutable records of achievement can capture performance in various activities, as agreed upon and documented between parties, on an immutable and distributed network that cannot be counterfeited or refuted. However, the actual and target data measurement can also be obfuscated from public view for public distribution of non-fungible tokens, while retaining the track record of achievement for specific entities and roles. These non-fungible tokens of achievement can be used for resumes and digital records such as on job search sites such as Indeed or LinkedIn.

Further, these contract achievement non-fungible tokens can be used to generate cryptocurrencies issued by entities corporations and be traded on exchanges, whereas the cryptocurrencies can represent additional contracts to receive further payments from the issuing entities. Tokens representing a variable level of achievement relative to contracted targets could represent a cryptocurrency token representing a stake in further variable payout by the issuing entity, even based on an entities ability to achieve future targets and stability with targets, through future dates. These issued non-fungible tokens could be held by the contracted entity achieving the contract or potentially traded on crypto currency exchanges.

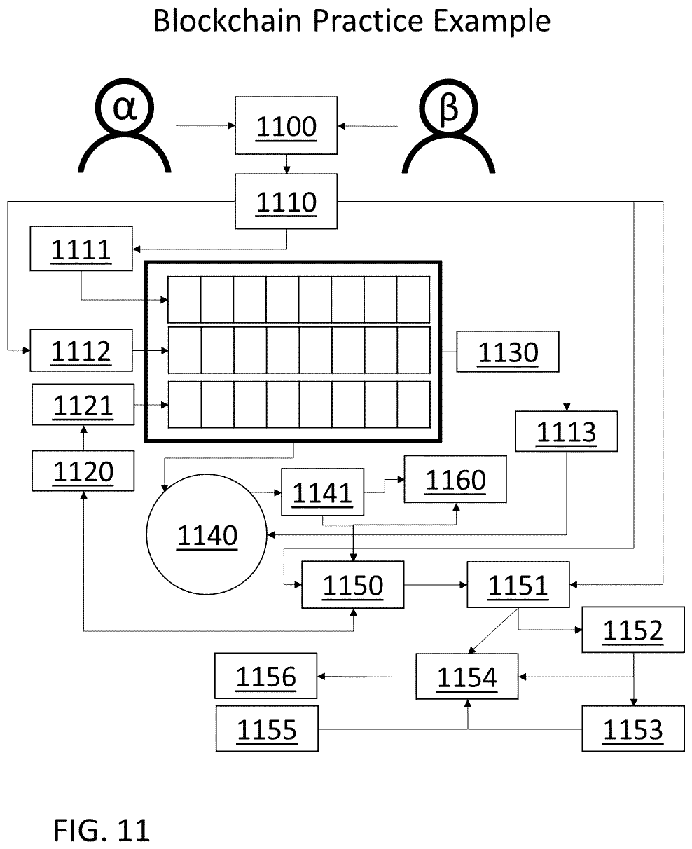

FIG. 11 depicts how the invention may be used in a smart contract context. For example, parties a and 13 may agree upon contract parameters involving variable payment terms 1100. The contract may be formed when parties a and 13 consent and deploy 1110 the contract. Sequence order identifiers 1111 and metric target measurement 1112 are provided. A trusted data source 1120 is used to provide actual metric measurements 1121 to form data gyro bulb source data 1130. 1113 from the smart contract supplies the metric compositions, calculation methods, and assessment means with corresponding variable payment algorithms. Then, data gyro bulb 1140 technology is used to output to a general user interface 1160 and to generate gyro bulb data blocks 1141.

As gyro bulb data blocks 1141 are generated, the data are also transmitted through a permission issuing and accessibility system to access a related blockchain ledger system. Optionally, the data passes to compiler system at 1152 which is capable of translating the data gyro bulb data blocks of 1141 and the smart contract language of 1110 into code that can be executed/deployed/ and invoked through a blockchain virtual machine or ledger system, such as into bytecode in some instances, and sometimes involves block hashing or encryption. Further optionality involves the translated data from the compiler at 1152 being passed to a virtual machine or docking system at 1153 which accesses a blockchain network's distributed ledger or docking systems for such blockchains as Ethereum or Fabric, where transaction encryption may occur. At 1154 the data gyro bulb's data blocks are invoked onto a digital ledger technology, often a distributed ledger technology, and invoked, deployed, or otherwise recorded on the ledger where/transactional hashing and encryption 1154 occurs or is implemented on the blockchain. 1155 and 1156 act as financial accounts or digital wallets capable of satisfying and receiving remitted payments in the form of funds represented as cash transfers, cryptocurrency, non-fungible tokens, cash equivalents, or other mediums of exchange. As a result, blockchain nodes are produced. Thus, automatic contract execution at 1154, 1155, 1156 results.

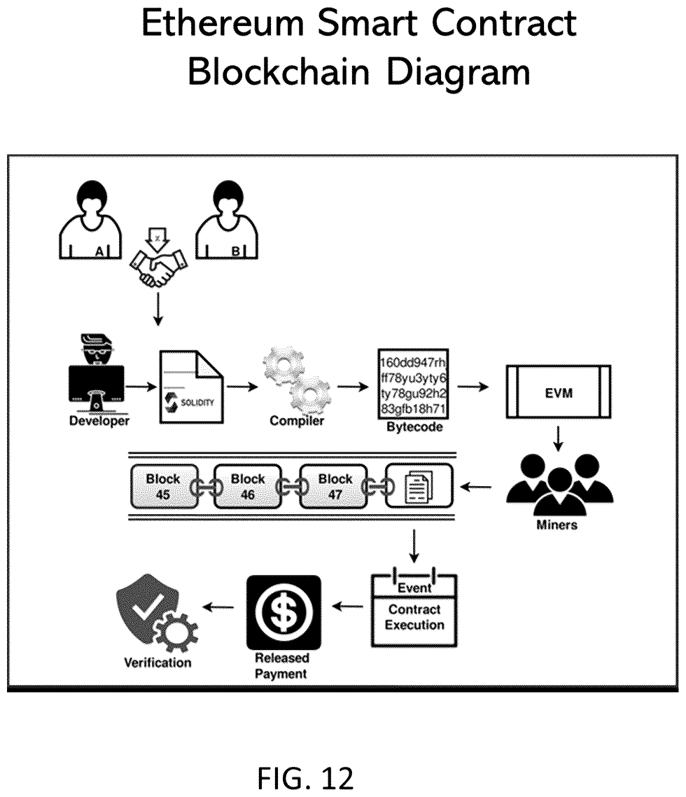

FIG. 12 is prior art to display the general overview of the smart contract process on a blockchain network. In this scenario, the Ethereum network is depicted.

As shown in FIG. 12, the invention may be used with cryptocurrency, e.g., Ethereum. Miners are computers running software that process transactions and produce blocks. Ethereum, like Bitcoin, currently uses an energy-intensive process called “mining” to create and distribute new cryptocurrency. Miners verify transactions on the Ethereum blockchain and get rewarded with ETH for their efforts.

Bitcoin, Ethereum and mining may currently be popular blockchain methods for smart contracts. However, the invention may also be compatible with a mining-less, decentralized blockchain network. In any case, the invention may allow for the introduction of biometric data into the data gyro bulb process, enabling gamification, tokenization, and smart contract reward systems between patients, monitoring companies, insurance plans, and providers through achievement and continuous optimization of health/biometric target levels via the implementation of data gyro bulb and associated zero gap technology.

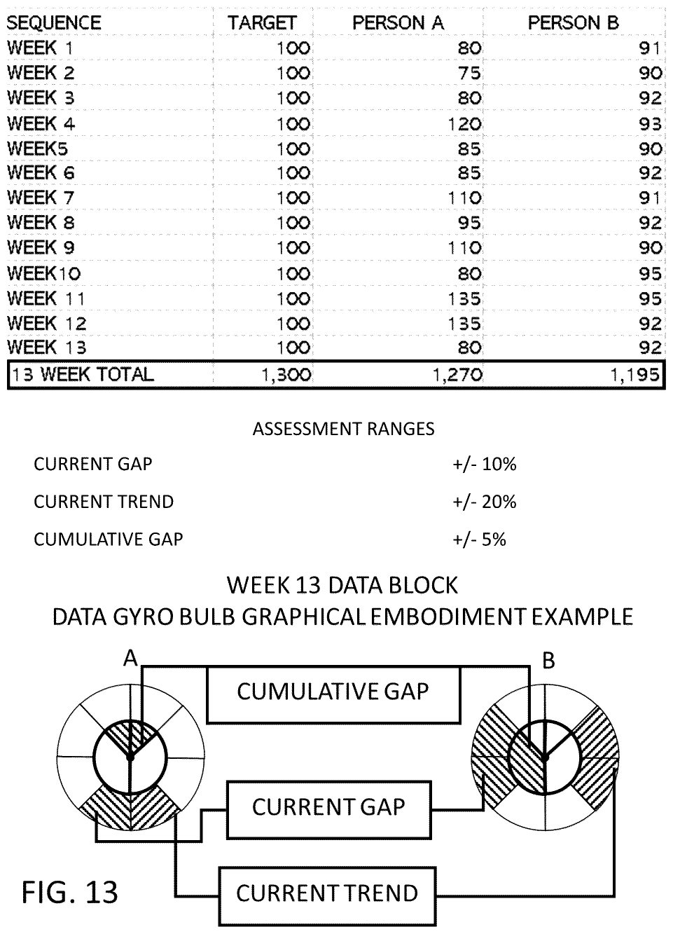

In FIG. 13, depicted is a weekly interval source data stream in the form of a table for two salespeople (A and B) over a thirteen-week sequence. Below the table are assessment means settings for a data gyro bulb. Below the settings are data gyro bulbs for both salesperson A and B at interval 13 of the source data stream sequence through the lens of the above assessment means.

Data Gyro Bulbs and the “Internet of Things” Technologies and Physical Sciences Application

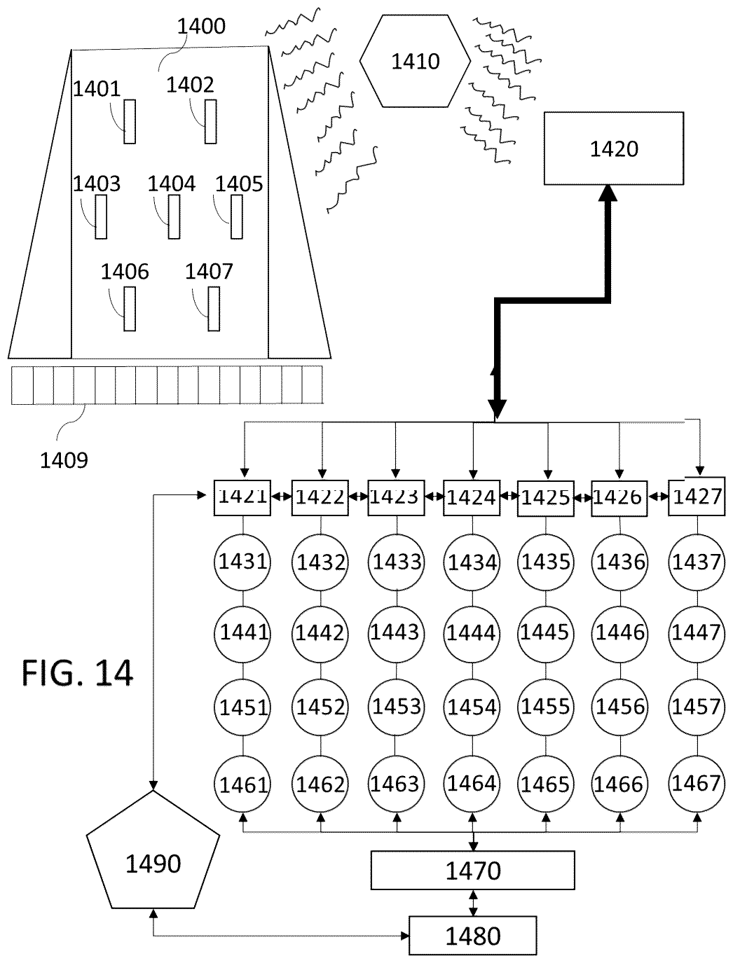

FIG. 14 depicts a system for metering, monitoring, and alerting a rail system of potential avalanches and landslides and recommending actions such as delayed routes and controlled landslide activations. A geological formation at risk of a landslide or avalanche onto a transport route such as a railway is represented at 1400. Metering devices capable of measuring the tilt, load, creep, and direction of the geological formation over data streams with continuous intervals and transmitting the actual interval measurements with ordinal identifiers such as timestamps are represented in 1401, 1402, 1403, 1404, 1405, 1406, and 1407. An exposed transport route such as a railway is shown as in 1409.

Also shown in FIG. 14 is a transmitter 1410 capable of receiving and transmitting metering device measurement data streams and sending to a data processing and storage device. A data processing and storage device 1420 is capable of receiving and transmitting the landslide metering device data sequence actual metric measurements. Data gyro bulb modules 1421, 1422, 1423, 1424, 1245, 1426, and 1427 capable of establishing interval targets and integrating with sequences of actual measurement data streams from landslide metering devices, composing metrics of a current gap, current trend, cumulative gap and cumulative trend, defining metric calculations, and establishing assessment means for multiple landslide metrics such as tilt, load, creep, and direction to create multiple data gyro bulbs for each meter.

Items 1431 to 1467 represent examples of individual data gyro bulbs created for each of the seven meters and four metrics each. While more or fewer might be created in practice, this is an illustrative example of the capability in practice.

A system of modules 1470 is provided to receive data gyro bulb metrics and assessment parameters with the ability to model various scenarios in parallel utilizing AI capabilities to solve complex equations and render alert scenarios faster, sooner, and with higher reliability by utilizing the data gyro bulb ordered processes and frameworks. Display modules 1480 are provided such that they are capable of translating the data gyro bulb data and frameworks and the modeled outputs form 1470 into graphical, audio, text, language, or other display mediums. An interface 1490 is also provided where users access and transmit alerts, insights, recommendations, graphics and other display methods as well as access the data gyro bulb source data, metric composition, metric calculation, and assessment modules.

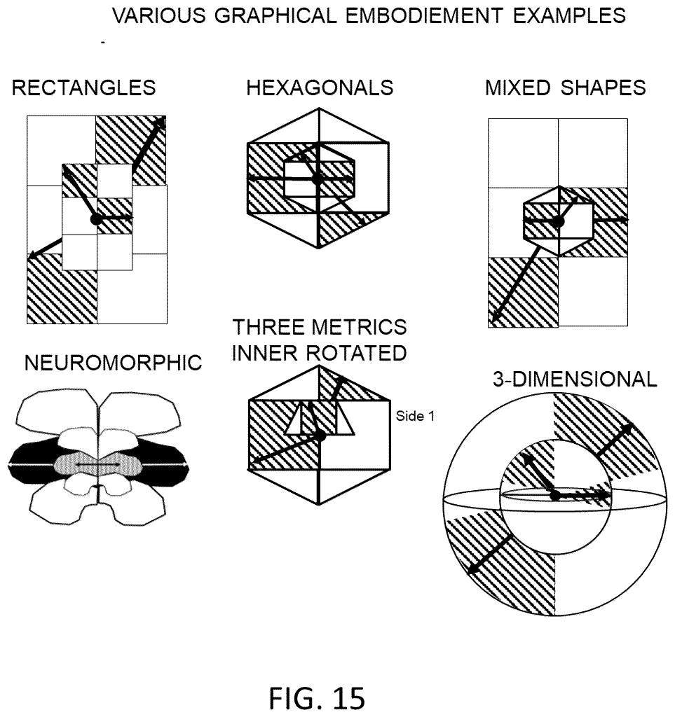

FIG. 15 shows an assortment of examples of graphical displays that could be generated with the data gyro bulb invention. Changes in color, size, pattern, shading, rotation, plotting of points, or creation of metric vectors can communicate the position of metrics on the graphical reference planes created by the graphics.

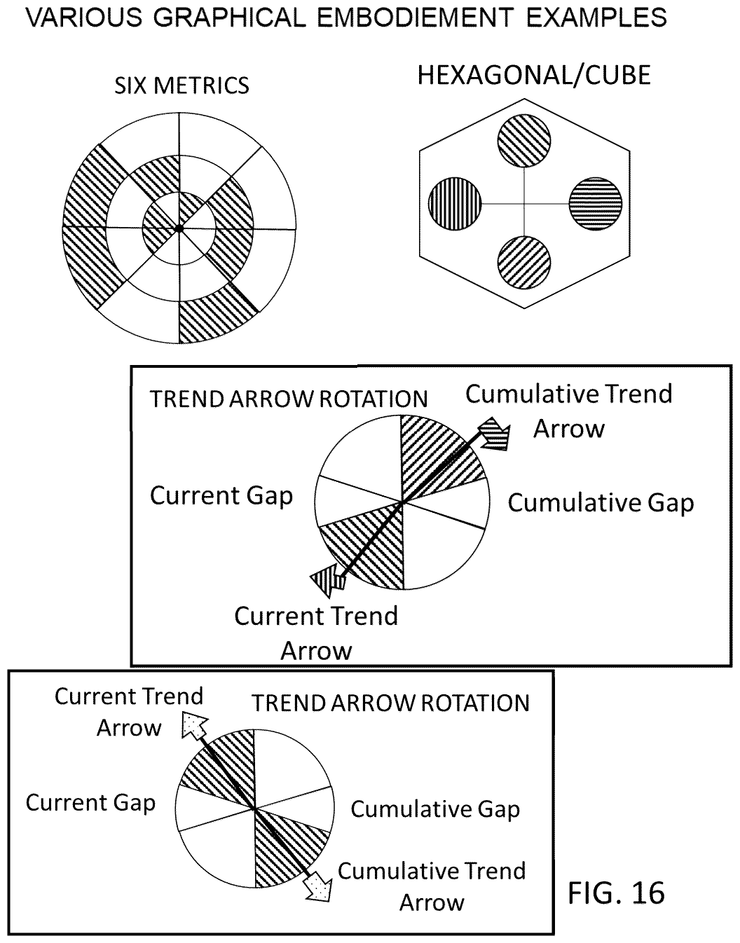

FIG. 16 shows an assortment of further examples of graphical displays that could be generated with the data gyro bulb invention. Changes in color, size, pattern, shading, rotation, plotting of points, or creation of metric vectors can communicate the position of metrics on the graphical reference planes created by the graphics.

Data Gyro Bulb Associated Zero Gap Technologies, Music, Physics, and Cryptocurrencies

Not only does the invention exhibit applicability in Web 3.0 and/or smart technology fields of technical endeavor, but the invention may also involve numerous advanced AI practices and methods. For example, in a further embodiment, the invention provides an AI generated data gyro bulb and an associated zero gap that is neither substantially positive nor substantially negative representing an ideal or precisely targeted state between an actual measured value and a target measured value. The inventive embodiment includes: an electronic computer-implemented data processor for carrying out a method for effecting informatics.

The method is comprised of: providing an electronically executable program stored at least partially in the memory and configured to be executed by the processor; receiving a sequential data stream of data blocks, wherein the stream of data blocks includes a genesis data block, and each data block of the stream of data blocks includes a sequence order identifier, an actual measurement, and a target measurement; and calculating derivative metrics of the sequential data stream for each of the data blocks, wherein the derivative metrics each includes at least one of a current gap, a current trend, a cumulative gap, and a cumulative trend. Importantly, the inventive data gyro bulb does not exhibit any rogue artifact that implicates, indicates, and or results in a consequential and detrimental phenomenon, incidence, or an occurrence from a user's perspective. Such rogue artifacts are to be avoided, e.g., in case insulin pumps relying on the invention are deployed to treat diabetics in a manner that avoids overdosing.

Thus, the invention provides numerous substantial improvements to known technologies, e.g., relating to AI. Variations of the present invention will be apparent to those of ordinary skill in the art, e.g., art involving AI and/or crypto, in view of the disclosure contained herein. For example, while the invention has been generally described in the context of computing machine, processors, and the like using and/or generating numerically based data blocks, the invention may be used in conjunction with nonnumerical values such as the notes associated with a chromatic, diatonic, and enharmonic scale/or the conventions associate with western music in an audio and/or modal scale. For example data gyro bulb source data and outputs may consist of sequences of notes. In some instances the source data and/or outputs may be from a selected from a base-twelve notation system having notes of A, A #/Bb, B, B #/Cb, C, C #/db, D, D #/Eb. E, E #/Fb, F, F #/Gb, G, and G #/Ab. The invention may also account for musical elemental systems involving melody, harmony, timbre, rhythm, and texture. Thus, the invention may, practically speaking, serve as a tool or instrument to “display” and/or “listen” to the music of analytics, or even to the cosmos, as exhibited by subatomic particles and associated waveforms.

In some embodiments of the invention, then, the inventive process may be carried out in view of data pertaining to one or more subatomic particles. In addition, the inventive process may be carried out using quantum computing technology, e.g., involving quantum states of electrons, e.g., traps, between a valence band and a conduction band or photonic transmission associated with transitions between different trap energy levels between the valence band and the conduction band.

The invention may also involve discrete and/or continuous numerical techniques. Such techniques may, for example, involve the electronic application of central limit theorem, mean and/or median analysis, standard and/or other types of deviation and/or derivative analysis, and/or tail characteristic analysis, e.g., such as those whose differences are exhibit by the normal gaussian curve and the student-T curve.

In any case, it should be noted that any embodiment of the invention may be modified to include or exclude features of other embodiments as appropriate without departing from the spirit of the invention. It is also believed that principles such as “economies of scale” and “network effects” are applicable to the invention and that synergies arising from the invention's novelty and nonobviousness increase with when the invention is practiced with increasing numbers of nodes, data, objects, memory capacity, processing speed, and/or the like. Appropriate usage of computerized and/or communication means, e.g., web-based hardware and/or software, cellular and land-based telephonic equipment, and antenna-based, satellite and cable television technologies, allow for further synergies.

It is to be understood that, while the invention has been described in conjunction with the preferred specific embodiments thereof, the foregoing description merely illustrates and does not limit the scope of the invention. Numerous alternatives and equivalents exist which do not depart from the invention set forth above. Other aspects, advantages, and modifications within the scope of the invention will be apparent to those skilled in the art to which the invention pertains.

For example, the invention provides a level of nuance and practicability in data analysis that are substantially infinite in nature. The invention may be used in big data applications involving, e.g., personalized medicine, supply chain analysis, microclimate calculations, carbon climate economics, etc. In addition, the invention is compatible with both hierarchical and/or relational database technologies and may optionally use fuzzy logic. Governmental applications of the invention may involve civilian and/or military applications.

In some instances, the invention may be applied to combat fraud or cyberspace hacking attacks. In such a case, the invention may involve techniques that develop trust between devices and nodes, e.g., through cryptographic and other techniques. Gamification (games) through cryptocurrency or other electronic currency sweepstakes may be carried out as well to provide interest to users.

All patents, patent applications, scientific literature and other publications mentioned herein are hereby incorporated by reference in their entireties to an extent not inconsistent with the description set forth above. Examples of such patents, patent publications, and other publications are enumerated below. When such patents, patent applications and/or publications are provided as hyperlinks, they are to be evaluated as of before the earliest priority date of the present case.

For literature associated with blood analytes and associated devices such as glucometers and continuous glucose monitoring systems, see, e.g., U.S. Pat. No. 6,258,046-B1 to Kimball et al. U.S. Pat. No. 6,258,046-B1 to Berger et al. and U.S. Pat. No. 6,607,658-B1 to Heller et al.

For an example of cryptocurrency patent literature, see Patent Cooperation Treaty Application PCT/US2019/038084 entitled “Cryptocurrency system using body activity data.” Copies of this literature in English and in French can be found via web-based searching functionality, e.g., at https://patentscope.wipo.int.

For possible relevant information relating to subatomic particles which may be applicable to embodiments of invention relating to subatomic particles such as neutrinos, see, https://icecube/wisc.edu.

Exemplary AI technologies having some relevance to the invention described herein are generally described in U.S. Pat. Nos. 9,779,407-B2 and 10,019,744-B2, each to Adjaoute.

The following examples show how the invention may be practiced in a definite manner as viewed from an ordinary artisan's perspective relative to enablement. Parts of the examples below are based on reality on parts of the examples below are prophetic in nature.

The examples are not intended to be limiting and may be practiced together, separately, and/or in a mixed manner.

### Example 1

An obese female 40-year-old human individual subject having a family history of adverse cardiovascular events schedules an appointment with her primary physician. She complains of not being able to sleep for nights on end. While the subject does not present with full on insomnia, the subject has only been able to get two or three hours of sleep for over a period of two weeks. In addition, the subject exhibits a general sense of malaise and has trouble concentrating at work.

The physician examines the subject and records a blood pressure of 140 mm Hg systolic and 90 mm diastolic. As a result, the primary physician makes an initial diagnostic of hypertension. In addition, the primary physician orders blood work and urine sample laboratory tests for the subject. The primary physician prescribes lisinopril, an ACE inhibitor to the subject. While the subject is reluctant to take any drug, the physician notes that the blood pressure readings are not sustainable over a long time, and the subject may suffer a cardiovascular event with a 50% chance of death. In addition, the subject is asked to return to see the primary physician in one month or less. Appropriate patient data/information is digitized and stored in electronic format, organized by date and time of the doctor's visit.

The physician also suggests the use of an electronic health/fitness/activity monitor, e.g., marketed under the trademark FitBit® or Samsung®, to track the subject's exercise sleep habits. Furthermore, the patient is also tasked to keep track of her daily habits involving other aspects of her health such as eating, drinking, etc., via an electronic diary.

In one month, the primary physician reviews the lab results of the subject and diagnoses the subject, from her A1C and blood sugar numbers, with uncontrolled Type II diabetes. The physician prescribed the subject an appropriate dosage of metformin, a drug available as a generic/off patent formation. In addition, the subject is asked to test her glucose levels at least daily using a glucometer or a continuous glucose monitor that operates by using a sensor having a portion that lies just underneath the subject's skin and a reader integrated with an app for recording the sensor readings using ordinary smart phone technology. The subject agrees. As a result, sequential electronic readings useful for the practice of the invention are obtained over time. A genesis data block is generated from electronic data from both the primary physician's records and from information contained in the patient's health/fitness/activity monitor, and from information the patient's diary.

Returning to the primary physician's visit, while the subject's blood pressure is acceptable, the subject has developed an uncomfortable and sporadic cough, a known side effect of ACE inhibitors. Thus, the physician, notes the cough in the subject's electronic records, and changes the lisinopril prescription to a losartan (Arb) prescription. All of the relevant medical information/data is stored electronically by time/date. The physician also asks the subject to buy an electronic blood pressure monitor so that data regarding the subject's blood pressure may be electronically tracked and analyzed between doctor's visits.

The subject also shows an undesirable low-density cholesterol to high-density cholesterol ratio. As a result, the physician also prescribes atorvastatin. Then, the subject is asked to return to see the physician after taking another blood test in about three to four months.

The subject agrees to follow her doctors' suggestions and uses the invention to track her exercise, diet, and bodily functions and variations thereof in a form that allows for sequential data block analysis. A genesis data block is created via AI means dating to the earliest of the doctors' office visits when the subject was 40 years old. Additional genesis data blocks may be generated for different aspects of information pertaining to her health. As a result, a feedback loop is created to alert the subject whenever she exhibits unhealthy symptoms and/or has medical measurement values that deviates substantially from a zero gap state.

For the next twenty years, via frequentative and periodic visits to her doctors, the subject lives a healthy and happy life, through the practice of appropriate dieting, regular physical exercise, optimal medication intake and good sleep hygiene habits.

Also, the patient's food intake and shopping habits are recorded in a smart device that also serves to monitor her blood sugar, pulse rate, blood oxygenation, sleep pattern, exercise pattern, etc. As a result, no cardiovascular surgical procedure is needed until the subject turns 80. Notably, the subject is able to lose a small, but significant amount of weight, thereby rendering her a more healthful person.

At the age of 80, the subject consents to stents to be implanted in her heart's blood vessels to provide her body with better cardiovascular performance. She continues to practice the invention along with good eating, exercise, sleep, medication. She lives happily until 100, a relatively long life for a person of her generation and lifestyle in view of her genetic profile.

Thereafter, the entirety of the subject's electronic data over her lifetime is collected and analyzed with data from others who have used the invention over their lifetimes. As a result, a systematic and holistic data analysis may be performed to assess which particularized factors may lead to a happy and healthy life, from a macroscopic population analysis perspective. In particular, the degree of influence of the particularized factors, e.g., diet, exercise, pulse rate, drug intake, etc., may be characterized and ranked as to their contribution to a happy, healthy, and long life.

### Example 2

In November, Acme Widget Company (AWC) hires two new salespeople, Salesperson A and Salesperson B, responsible for the total gross sales of its new widget across its two territories. Both have stellar sales track records with high performance across the widget industry. Each has equivalent progressing seniority of fifteen years of experience, consistently achieving success at each level of sales within their organizations.

AWC is focused on “just-in-time” (JIT) and “lean manufacturing” (LM) supply-chain practices to reduce waste and inventory carrying costs, to maximize its net earnings. AWC negotiates the compensation terms with Salesperson A and Salesperson B. The compensation for the Salespeople has both base-pay and sales commission components. However, the sales commissions are variable and based on both overall sales and consistency of sales each week. This to say that Salesperson A and B can optimize their sales commission compensation by achieving predetermined target volumes of widget sales for each week, across thirteen-week quarterly cycles. Therefore, there is a combination of consistency and longevity in the calculation of sales commission compensation. Weeks recording a variance, or gap, with that week's predetermined target are set to payout lower percentages of commissions. However, recognizing that fulfilling the precise target each week and over the duration is nearly impossible, and to entice these high performing Salespeople, AWC allows for a range of variance above and below the weekly and quarterly targets that will continue to pay the optimal commission payout per unit sold.

Because AWC is concerned with JIT and LM practices to reduce waste and inventory costs, there is also a matter of stability emphasized, beyond the matter of consistency. This means that wild fluctuations in the variance gaps between the weekly target sales will diminish the commission payout potential. This is, if a salesperson drastically underperforms one week and then overperforms the next, this creates wild fluctuations in demand for the widgets and resource requirements, inclusive of overtime, system maintenance, and source materials. These fluctuations come with inherent increased unit costs. Therefore, the value of the commission payouts is detrimentally impacted by such wild trends in the weekly gap to target.

To summarize, the compensation structure for Salesperson A and B, each contract has two components, one of base pay and the other of a sales commission, where the sales commission is variable. This variable payment is based on a Salesperson's ability to consistently sell a predetermine target number of widgets for each week and levels of stability relative to targets week over week, within ranges of acceptability, over the duration of the quarter to realize the optimal commission payout. Additionally, the variable commission payment considers the cumulative sales over the quarter within a range of acceptability, to achieving the highest per unit sales commission payment.

For example, suppose in week three of the first quarter of 2023 Salesperson A has a sales target of 100 widgets with +/−10% and logs sales of 85 widgets that week (a weekly gap of −15 or −15%). In this scenario, the per unit sales commission would be reduced for not achieving the target range. Furthering to the example, the following week (week four of first quarter 2023) Salesperson A has a weekly sales target of 100 widgets with a range of +/−10% and logs sales of 110 (a gap of +10 or +10%). In this scenario, there would be reductions in week four's commission due to a trend in in the gap to the target between weeks of +25 widgets (25% trend in gap). Despite week four falling within the +/−10% weekly target range, Salesperson A suffers a penalty due to a swing in the weekly gap that make JIT and LM adjustments costly to manage.

It is important to note that at the end of the thirteen-week quarter, each Salesperson is provided with a variable sales commission for achieving the cumulative quarterly sales target, within a predetermined range. Therefore, the penalty for exceeding the weekly target in week four, thus driving volatility in the variance week-to-week, will ultimately help in achieving balance with the cumulative quarterly sales target. However, this type of balance does not payout as optimally as if Salesperson A consistently achieves the sales target range each week.

In another demonstration, focusing on the cumulative aspect of the variable sales commission payout terms, if Salesperson B achieves each weekly target over the 13 weeks, within the predetermined +/−10% range, wherein each week the actual recorded sales is below target at −7% weekly, and the quarterly sales is more restrictive at +/−5%, Salesperson B would be paid the optimal per unit sales commission for each week, however the quarterly sales commission payout would be reduced. Conversely, if Salesperson B consistently exceeds the weekly sales target by +9%, the weekly per unit sales commissions will be optimized on a per unit basis, however the quarterly sales commission could also be reduced due to overstress and increased costs related to fulfillment of the persistent over target sales through the quarter. Overtime costs, last-minute input material orders, and additional maintenance on machinery can increase the variable costs due to consistently fulfilling sales orders that are above the planned capacity.

Salesperson A and B are each provided with access to the records of existing customers and prospective customers within their assigned territories, including the necessary contact information such as emails, phone numbers, and addresses. Each is also supplied with a company car, computer, and phone with internet access and access to the company's software, servers, and databases. Specifically, the company provides each access to its customer relationship management software to record all sales activity inclusive of emails, phone calls, and visits. Phones, computers, and cars are integrated with internet of things (IoT) technologies that automatically log when an email, phone call, in-person visit, and purchase order execution in real-time. That is, all relevant sales activities are automatically logged into ACW's customer relationship and accounting software applications, e.g., as electronic data, as they occur.

AWC has an established track record of successful widget sales. Through its historical data collection and analytics, the company has quantified the estimated number of each of the sales activities (phone calls, emails, in-person visits, purchase orders) by day, week, and month, for existing and prospective clients, that are historically required to achieve the target sales of widgets within each Salesperson's territory. Each Salesperson is provided with these target metrics to generate the target sales within their territories over the coming quarter. These target data are saved into the memory company's customer relationship software with assignment to each Salesperson A and B. AWC also has established approved email communication templates and sales scripts for current and prospective customers that are to be utilized by all Salespeople, which are also supplied to Salesperson A and B.

As quarter one of the following year commences, the variable sales commission contracts are set, in conjunction with the JIT and LM production planning. The weekly target for new widget sales is set at 100 per week. Each week there is an acceptable range of +/−10% (10 widgets) and the cumulative quarterly sales of 1,300 widgets has a range of +/−5% (65 widgets). Furthermore, the weekly trend of variance to the target has a range of +/−15% between weeks. Achieving between 90 and 110 widgets per week, within 15% variance volatility, and selling 1,235 to 1,335 widgets will automatically result in a variable sales commission of 8% of gross sales. Deviating from these ranges on a weekly basis, between weeks, or at the end of the quarter reduces the variable sales commission percentage of gross sales.

Salesperson A and B each execute against the sales activities to produce sales for quarter one of 2023. FIG. 13 contains a table of the weekly target widget unit sales and the actual unit sales, by week for each Salesperson A and B, along with a total for the thirteen-week quarter one of 2023. Salesperson A achieves the weekly target within range in only three of the thirteen weeks and repeatedly returns current trend sales variance volatility between weeks that is outside of the assessment range for the current trend. However, Salesperson A achieves cumulative sales within the +/−5%, logging a total of 1,270 (−2%) widget unit sales for the quarter. Salesperson B consistently meets the weekly target widget unit sales range across all weeks and did so with minimal variance volatility between weeks. However, Salesperson B delivers cumulative quarterly sales below the +/−5% range, at 1,195 (−8%). As per the variable sales commission contracts, Salesperson A earns an average per unit sales commission of 3% of gross sales and Salesperson B earns a commission that is 6% of gross sales per unit sales. This means that Salesperson B will earn over 88% more in sales commission payment than Salesperson A, despite selling nearly six percent fewer widget units. Data gyro bulb graphical embodiments of the Week 13 data block are displayed below the table and assessment ranges. In these embodiments the three contractual metrics are composed and rendered, with the cumulative gap displayed in the center circular shape with one range, the current gap displayed on the left side of the outer circle with the current gap assessment range, and the current trend is displayed on the right side of the outer circle with its assigned assessment range. From these rendered graphics, it can be intuitively interpreted that Salesperson A is within range cumulatively as of the week 13 data block, but is currently below week 13 current target range and this is also a decrease in gap that is outside of the 20% trend acceptability. Salesperson B data gyro bulb graphically displays below the cumulative gap assessment range, while on-target for week 13 and is also demonstrates stability in in the current gap from week 12 to week 13.

Salesperson A is unhappy with this result. Further, Salesperson A reflects on the sales activity logs. After extensive data exploration and statistical analysis patterns appear both within his weekly sales activity and the resulting weekly orders, as well as Salesperson B's sales activities and purchase orders. Salesperson B has executed far fewer activities and generated more response and purchase orders utilizing the same scripts and email templates. In fact, Salesperson A determined through the analysis that the lists appear to be of vastly difference in quality and Salesperson A was required to substantially exceed weekly sales activities to achieve the weekly target while Salesperson B has conducted far fewer activities to be within the range. Given both Salespeople are of similar experience with track records of success, provided with the same email templates and scripts, all activities and customer responses are automatically logged into the system, Salesperson A requests adjustments to the sales contracts.

Salesperson A makes requests to adjust how the variable sales commissions are managed and that resources be made available that provide real time analyses, insights, and recommendations regarding needed sales activities, optimizing purchase order fulfillment, and the development of smart-contracts that execute immediate and seamless payments. As a result, a new smart-contract system will consider both the sales activities and sales outcomes to ensure equitable offsets to accommodate for the assigned leads and contacts that are not of equal quality between Salespeople. Smart contracts can trigger automatic variable payments for reaching combinations of sales activities within each week, along with achieving unit sales of widgets. A management system provides intuitive analyses and informatics with insights and recommendations to direct which sales activities should be increased or decreased at a given day or week. Additionally, Salesperson A requires a means of receiving automated alarms and alerts when sales will be out of range in each week, cumulatively over the quarter, or demonstrating out-of-range variance volatility between weeks and providing direction on when to reduce or pursue various sales orders. With the deployment of smart-contract and in combination of the IoT technology embedded in AWC's system, payments are made seamlessly and instantaneously.

Because AWC values sought after Salespeople and is seeking to build a team with demonstrated track records of optimized performance within the JIT and JM, management at the company investigates what processes and systems can satisfy these needs. Through the deployment of data gyro bulb blockchain technologies and its integrated smart-contract creation, these requests are easily embedded and automated into the sales technologies and processes at AWC. Now, Salesperson A and B have variable compensation contracts that align to both activities and outcomes towards achieving the JIT and LM priorities to reduce waste and costs. The data gyro bulb technology effectively provides for a more stable salesforce and predictive feedback loop to production and to anticipate and reduce the gaps and volatilities between production, demand, and inventories of widgets.

### Example 3

A landslide metering company has been contracted to establish a metering and monitoring system along the mountains of the Glacier Express railway. The company deploys meters that capture data readings for tilt, direction, creep, and load across various points throughout the Glacier Express railway. The role of the company is to monitor and advise the railway operators of the dangers of landslides and avalanches year-round and recommend when it might be prudent to delay routes and activate a controlled slide utilizing explosive. The company's metering and monitoring systems are integrated into a network of IoT capabilities, that involve wireless communications, dataloggers, wireless nodes, long-range radio, cellular networks, and arial drone surveillance and data capture.

A tremendous amount of time-stamped monitoring data is collected from each metering system, and for each metric. The data are compiled in an integrated database management platform and analyzed through a variety of complicated processes. Because there are combinations of sequential changes in tilt, direction, creep, and load across multiple meters in the monitoring network, the analysis and recommendations require significant time to assess and simulate. This is largely due to a lack of integrated, consistent, and yet flexible process, framework, and architecture by which to analyze and simulate the various types of data and probabilistic outcomes. Further, adapting and changing the parameters to analyses are opaque, complex, and time-consuming, requiring teams of programmers, data scientists, geologists and seismologists engaged in inefficient communication chains to access models and review changes to the alert parameters and simulation outcomes/

The company has invested considerable amounts into the hardware that captures and collects the data, transmission of data, and the structured storage of data. Analyzing and monitoring the various metric results over time and across metering devices is not intuitive, consistent, or flexible. Because time is of the essence in the advice and recommendations based on the sequential data, where seismologists can provide recommendations for the railway and government agencies, there is a need for an analytical informatics system that enables the seismologists to process various scenarios with flexible inputs that provide consistent and intuitive analyses of various sequences, with various intervals, over various metrics. These analyses need to be based on expected target values, and alert to when combinations of the various metrics are out of the target expected ranges or experiencing volatility for a given sequence, at intervals or over the cumulative sequence. Further, it was needed that the data scientists and seismologists could automate and apply changes to the ranges themselves, without the need for software programmers to untangle complex “spaghetti code”.

This situation can benefit from the use of the inventive data gyro bulb. The analytical framework, open architecture, and intuitive outputs enable experts in geology, seismology, and data science to condense analyses and simulate multiple scenarios, with the ability to adjust assessment means ranges of acceptability in real time. The standardized process of receiving structured data streams, composting and calculating data gyro bulb derivatives, interpreting the derivatives through the intuitive, flexible, and directly accessible insights assessment architecture comprised of the zero-points, ranges, and limits integrate to enable outputs, graphics, and easy simulations over various sequences and intervals. Further, AI capabilities can be deployed using the data gyro bulb processes and frameworks that enable parallel processing and vast computations of the structured metrics and assessment architectures to improve speed and efficacy of metering, monitoring, and alert detection scenarios. Applying the data gyro bulb invention to this scenario could save lives, as well as time and money for the railway and the landslide metering company.

FIG. 14 is a diagram to illustrate how a landslide metering company ca deploy data gyro bulb technology in the use of monitoring, alerting, and recommending actions to halt transportation services and initiate controlled landslide practices. 1600 represents a geological surface at risk for landslides above a section of rail track 1609. Meters have been strategically places across the geological formation and represented by 1601, 1602, 1603, 1604, 1605, 1606, and 1607. The meters are capable of accurately measuring tilt, load, creep, and direction of the formations at their points and transmit the data wirelessly over continuous intervals with sequence order identifiers at each interval to a receiver and transmitter at 1610. These transmitted data streams will be integrated as two of the three needed elements of the data gyro bulb source data.

The wireless transmitter at 1610 relays the metrics' actual measurement and sequence order data to modules capable of receiving the transmission and processing and storing the data at element 1620. The data can then be submitted to data gyro bulb systems for each monitor represented by 1621, 1622, 1623, 1624, 1626, and 1627. In these systems the sequence order identifiers, actual metric measurements, target data for each metric at each interval, metric compositions, calculations methods, and assessment means can be stored and managed. A data gyro bulb may be deployed for each of the four metrics from each meter. For instance, the tilt metric data gyro bulbs could be represented by 1631, 1632, 1633, 1634, 1635, 1636, 1637, while the load metric data gyro bulbs could be represented by 1641, 1642, 1643, 1644, 1645, 1646 all relating back to the specific meters on the formation.

The data gyro bulb data can be passed to a modeling program that may have AI capabilities at 1670 and can use the data gyro bulb processes and assessment constructs to alert the metering company geologists and seismologist earlier, faster, and with more accuracy than traditional methods. Further the modeling data is passed to display modules at 1670 and transmit displays to general user interfaces at 1680 that can access the data gyro bulb structured processes and frameworks for users (seismologists, geologists, and AI) to directly create and simulate various source data, metric compositions, metric calculations, and assessment criteria across the tilt, load, creep, and direction metrics of the metering system. This enables users with expertise in the field to gain direct access to the data gyro bulb processes and constructs in a consistent, intuitive, and yet flexible formats. Understanding the gaps to target tilt, load, creep, and direction data, as well as how these gaps are changing, at various interval and cumulative sequences as well as within ranges of acceptability delivers much needed capabilities not currently available in structured, intuitive, and ordered processes and frameworks.

What is claimed is:

1. An electronic informatics system, comprising:
a sequential data streams of data blocks, wherein the stream of data blocks comprises a genesis data block, and each data block of the stream of data blocks includes a sequence order identifier, an actual value, and a target value;
a set of metrics that each includes one or more metric components selected from a current gap, a current trend, a cumulative gap, and a cumulative trend;
a calculating means for calculating a derivative metric at each of the data blocks; and
an assessing means for assessing metrics in a manner that is consistent with a zero measurement that is neither substantially positive nor substantially negative,
wherein the system operates via gyro, bot, and/or user adjustment technology to carry out data processing to produce one or more data gyro bulbs.

2. The electronic informatics system of claim 1, further comprising systematic instructions for creating, managing, and/or executing one or more smart contracts between entities,
wherein payment terms of the one or more smart contracts are variable and dependent on the one or more derivative metrics relative to associated values, ranges, and scales, at predetermined contractual intervals of the sequential data stream.

3. The electronic system of claim 2, wherein the data of the contract is executed and tokenized on Web 3.0 decentralized networks with cryptographic communication protocols and creates and distributes cryptocurrencies that act as further smart contracts to the rights for future payments to the holders of the units of the cryptocurrency.

4. The electronic system of claim 2, wherein the data of the executed contract is tokenized on Web 3.0 decentralized networks with cryptographic communication protocols and creates proof-of-work and employment performance records that can be tokenized and distributed across networks.

5. The electronic informatics system of claim 1, further comprising systematic instructions for alerting and directing care for a diabetic individual.

6. The electronic informatics system of claim 5, wherein the systematic instructions for directing care for the diabetic individual includes an actual measured value and a target measurement value for blood glucose, A1C, and/or insulin values of the individual.

7. The electronic informatics system of claim 6, wherein the systematic instructions include and/or incorporate data representing overall health of the individual.

8. The electronic informatics system of claim 7, wherein the systematic instructions include and/or data representing, blood pressure, heart rate, sleep pattern, sleep habit, exercise pattern, exercise habit, diet pattern, diet habit, physical activity, activity intensity, pharmacological information, and/or nutritional information.

9. The electronic informatics system of claim 1, further comprising instructions for receiving and displaying public health metrics, wherein the system identifies, alerts, and directs users and systems to prioritize actions and resources to manage desired public health outcomes.

10. The electronic informatics system of claim 1, further comprising a display that displays an object that represents at least an aspect of the data gyro bulb.

11. The electronic information of claim 1 effective to facilitate financial and business analysis and to automate arbitrage.

12. The electronic informatics system of claim 1, effective to facilitate business and financial analysis wherein the system identifies, alerts, and directs users and systems to business priorities and controls to automate actions and resource allocations that affect and effect business and financial outcomes.

13. The electronic informatics system of claim 1, effective to facilitate a geological metering, monitoring, analysis, and alert system.

14. The electronic informatics system of claim 1, effective to facilitate an air, water, or soil quality metering, monitoring, analysis, and alert system.

15. An electronic process allowing for frequentative data processing using a processor and a memory adapted to carry out informatics, comprising:
providing an electronically executable program stored at least partially in the memory and configured to be executed by the processor;
receiving a sequential data stream of data blocks, wherein the stream of data blocks includes a genesis data block, and each data block of the stream of data blocks includes a sequence order identifier, an actual measurement, and a target measurement;
calculating derivative metrics of the sequential data stream for each of the data blocks, wherein the derivative metrics each includes at least one of a current gap, a current trend, a cumulative gap, and a cumulative trend; and
generating a data gyro bulb to facilitate a zero gap and/or zero trend between actual data measurements and target data measurements.

16. The electronic process of claim 15, wherein the process is carried out to effect one or more smart contracts.

17. The electronic process of claim 16, wherein the process is carried out to control, monitor and/or improve web traffic, sales activities, or advertising reach.

18. The electronic process of claim 15, carried out in view of data pertaining to one or more subatomic particles.

19. The electronic process of claim 15, carried out using quantum computing technology.

20. An AI generated data gyro bulb and an associated zero gap and zero trend that is neither substantially positive nor substantially negative, comprising:
an electronic computer-implemented data processor for carrying out a method for effecting informatics, the method comprising
providing an electronically executable program stored at least partially in the memory and configured to be executed by the processor,
receiving a sequential data stream of data blocks, wherein the stream of data blocks includes a genesis data block, and each data block of the stream of data blocks includes a sequence order identifier, an actual measurement, and a target measurement,
calculating derivative metrics of the sequential data stream for each of the data blocks, wherein the derivative metrics each includes at least one of a current gap, a current trend, a cumulative gap, and a cumulative trend,
wherein the AI data gyro bulb does not exhibit any rogue artifact to a consequential and detrimental degree for a user.
